(19) United States
(12) Patent Application Publication
(10) Pub. No.: US 2003/0053658 A1
(43) Pub. Date: Mar. 20, 2003

(54) Surveillance system and methods regarding same

(75) Inventor: Ioannis Pavlidis, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ

(21) Appl. No.: 10/034,696

(22) Filed: Dec. 27, 2001

Related U.S. Application Data
(60) Provisional application No. 60/302,020, filed on Jun. 29, 2001.

(51) Int. Cl. G06K 9/00

(52) U.S. Cl. 382/103; 382/107

(57) ABSTRACT

A system and method for use in monitoring a search area includes positioning a plurality of imaging devices at one or more installation sites such that corresponding fields of view for the plurality of imaging devices cover a defined search area. For example, each field of view of each imaging device may include a field of view portion which overlaps with at least one other field of view of another imaging device, e.g., the field of view portion which overlaps may be greater than about 25 percent and less than about 85 percent of the field of view of the imaging device. Further, for example, images may be fused using one or more homography transformation matrices.

### CROSS-REFERENCE TO RELATED APPLICATIONS

This application claims the benefit of U.S. Provisional Application No. 60/302,020, entitled “SURVEILLANCE SYSTEM AND METHODS REGARDING SAME,” filed Jun. 29, 2001, wherein such document is incorporated herein by reference.

### BACKGROUND OF THE INVENTION

The present invention relates generally to systems and methods for monitoring a search area. More particularly, the present invention pertains to monitoring a search area for various applications, e.g., tracking moving objects, surveillance, etc.

Providing security in various situations has evolved over a long period of time. Traditionally, the security industry relies primarily on its human resources. Technology is not always highly regarded and sometimes is viewed with suspicion. For example, one of the last universally-accepted technological changes in the security industry was the adoption of radio communication between guarding parties.

Although video recording has been used by the security industry, generally, such recording has not been universally adopted. For example, there are significant portions of the security market that do not use video recording at all and rely exclusively on human labor. One example of the use of human labor is the majority of stake-out operations performed by law enforcement agencies.

In general, the infrastructure of the security industry can be summarized as follows. First, security systems generally act locally and do not cooperate in an effective manner. Further, very high value assets are protected inadequately by antiquated technology systems. Lastly, the security industry relies on intensive human concentration to detect and assess threat situations.

Computer vision has been employed in recent years to provide video-based surveillance. Computer vision is the science that develops the theoretical and algorithmic basis by which useful information about the world can be automatically extracted and analyzed from an observed image, image-set, or image sequence from computations made by a computing apparatus. For example, computer vision may be used for identification of an object's position in a cluttered environment, for inspection or gauging of an object to ensure components are present or correctly sited against a specification, and/or for object navigation and localization, in order for a mobile object to be tracked to determine its position relative to a global coordinate system. In many cases, use of computer vision has been focused on military applications and has employed non-visible band cameras, e.g., thermal, laser, and radar. For example, an emphasis was on the recognition of military targets.

However, computer vision has also been employed in surveillance applications in non-military settings using visible band cameras. For example, such surveillance systems are used to perform object recognition to track human and vehicular motion.

Various computer vision systems are known in the art. For example, computer vision tracking is described in an article by C. Stauffer and W. E. L. Grimson, entitled “Adaptive background mixture models for real-time tracking,” in Proceedings 1999 IEEE Conference on Computer Vision and Pattern Recognition, vol. 2, pp. 246-252, Fort Collins, Colo. (Jun. 23-25, 1999). However, there is a need for improved accuracy in such tracking or surveillance systems and methods.

Further, even though object motion detection methods are available to track objects in an area to be monitored, generally, such systems do not provide a manner to adequately evaluate normal or abnormal situations, e.g., threatening versus non-threatening situations. Generally, existing commercial security systems rely primarily on human attention and labor to perform such evaluation.

### SUMMARY OF THE INVENTION

A monitoring method and system that includes one or more of the following components are described herein. For example, such components may include an optical component, a computer vision component, and/or a threat assessment component.

For example, the optical component may include the placement of imaging devices, the fusion of the fields of view of the imaging devices into a calibrated scene (e.g., a single image), and/or the matching of the calibrated scene to a respective computer aided design or file. Further, for example, the computer vision component may include moving object segmentation and tracking which operates on the calibrated scene provided by the optical component. Yet further, the threat assessor may draw inferences from annotated trajectory data provided by the computer vision component.

A method for use in monitoring a search area according to the present invention includes providing a plurality of frames of image pixel data. The plurality of frames of image pixel data include at least one frame of image pixel data representative of a corresponding field of view for each of a plurality of imaging devices. Each field of view of each imaging device includes a field of view portion which overlaps with at least one other field of view of another imaging device. The plurality of frames of image pixel data are combined into a single image representative of at least a portion of the search area by computing at least one homography transformation matrix indicative of a coordinate relationship between image pixel data for fields of view of at least one pair of the imaging devices that include field of view portions which overlap with each other, e.g., the overlap being greater than about 25 percent of the field of view of the imaging device, the overlap being less than about 85 percent of the field of view of the imaging device.

In one or more embodiments of the method, the at least one homography transformation matrix may be computed based on a plurality of landmark points of commonality in the field of view portions which overlap for the at least one pair of the imaging devices, the plurality of frames of image pixel data may be combined into a single image representative of at least a portion of the search area using the homography transformation matrix to fuse the plurality of frames of image pixel data into a single image having a global coordinate system, a plurality of imaging devices may be positioned to cover an entire defined search area having an outer perimeter edge, a moving object may be tracked within the single image resulting in a moving object path for the moving object, and it may be determined whether the moving object path is normal or abnormal.

A system for use in monitoring a search area according to the present invention includes a plurality of imaging devices operable to provide a plurality of frames of image pixel data. The plurality of frames include at least one frame of image pixel data representative of a corresponding field of view for each of the plurality of imaging devices. Each field of view of each imaging device includes a field of view portion which overlaps with at least one other field of view of another imaging device. The system further includes a computing apparatus operable to combine the plurality of frames of image pixel data into a single image representative of at least a portion of the search area by computing at least one homography transformation matrix indicative of a coordinate relationship between image pixel data for fields of view of at least one pair of the imaging devices that include field of view portions which overlap with each other, e.g., the overlap is preferably greater than about 25 percent of the field of view of the imaging device and the overlap is preferably less than about 85 percent of the field of view of the imaging device.

In one or more embodiments of the system, the computing apparatus may be further operable to compute at least one homography transformation matrix based on a plurality of landmark points of commonality in the field of view portions which overlap for the at least one pair of the imaging devices, the computing apparatus may be further operable to use the homography transformation matrix to fuse the plurality of frames of image pixel data into a single image having a global coordinate system, the plurality of imaging devices may be positioned to cover an entire defined search area having an outer perimeter edge, the computing apparatus may be further operable to track a moving object within the single image resulting in a moving object path for the moving object, and the computing apparatus may be further operable to determine whether the moving object path is normal or abnormal.

Another method for use in monitoring a search area includes defining a search area having an outer perimeter edge and positioning a first imaging device at a first installation site such that a field of view for the first imaging device covers at least a region of the defined search area along at least a portion of the outer perimeter edge thereof. One or more additional imaging devices may be positioned at the first installation site, if necessary, to cover with fields of view thereof one or more additional regions of the defined search area not covered by the field of view of the first imaging device. In addition, one or more additional imaging devices may be positioned at one or more additional installation sites, if necessary, to cover with fields of view thereof one or more additional regions of the defined search area not cover by fields of view of the imaging devices positioned at the first installation site. Each field of view of each imaging device includes a field of view portion which overlaps with at least one other field of view of another imaging device; the field of view portion which overlaps is preferably greater than about 25 percent of the field of view of the imaging device.

In one or more embodiments of the method, the fields of view of the imaging devices provide for coverage of the entire search area, the field of view portion which overlaps is less than about 85 percent of the field of view of the imaging device, and one or more of the imaging devices are adjusted based on at least a calculated limiting range of at least one of the imaging devices indicative of the useful coverage area for the imaging device (i.e., the limiting range being based on the field of view of the imaging device and the resolution of the imaging device).

Another system for use in monitoring a search area according to the present invention includes a first imaging device positioned at a first installation site such that a field of view for the first imaging device covers at least a region of a defined search area along an outer perimeter edge thereof and one or more additional imaging devices positioned at the first installation site, if necessary, to cover with fields of view thereof one or more regions of the defined search area not covered by the field of view of the first imaging device. Further, the system includes one or more additional imaging devices positioned at one or more additional installation sites, if necessary, to cover with fields of view thereof one or more additional regions of the defined search area not covered by the fields of view of the imaging devices positioned at the first installation site. Each field of view of each imaging device includes a field of view portion which overlaps with at least one other field of view of another imaging device; wherein the field of view portion which overlaps is greater than about 25 percent of the field of view of the imaging device.

In one or more embodiments of the system, the fields of view of the imaging devices may provide for coverage of the entire search area, the field of view portion which overlaps is preferably less than about 85 percent of the field of view of the imaging device, the position of one or more of the imaging devices may be based on at least a calculated limiting range of at least one of the imaging devices indicative of the useful coverage area for the imaging device (i.e., the limiting range being based on the field of view of the imaging device and the resolution of the imaging device).

Yet another method for use in monitoring a search area according to the present invention includes defining a search area and positioning a plurality of imaging devices at one or more installation sites such that corresponding fields of view for the plurality of imaging devices cover the entire search area. Each field of view of each imaging device includes a field of view portion which overlaps with at least one other field of view of another imaging device. The field of view portion which overlaps is greater than about 25 percent of the field of view of the imaging device.

In one or more embodiments of the method, the field of view portion which overlaps is preferably less than about 85 percent of the field of view of the imaging device and one or more of the plurality of imaging devices may be adjusted based on at least a calculated limiting range of at least one of the imaging devices indicative of the useful coverage area for the imaging device.

The above summary of the present invention is not intended to describe each embodiment or every implementation of the present invention. Advantages, together with a more complete understanding of the invention, will become apparent and appreciated by referring to the following detailed description and claims taken in conjunction with the accompanying drawings.

### BRIEF DESCRIPTION OF THE EMBODIMENTS

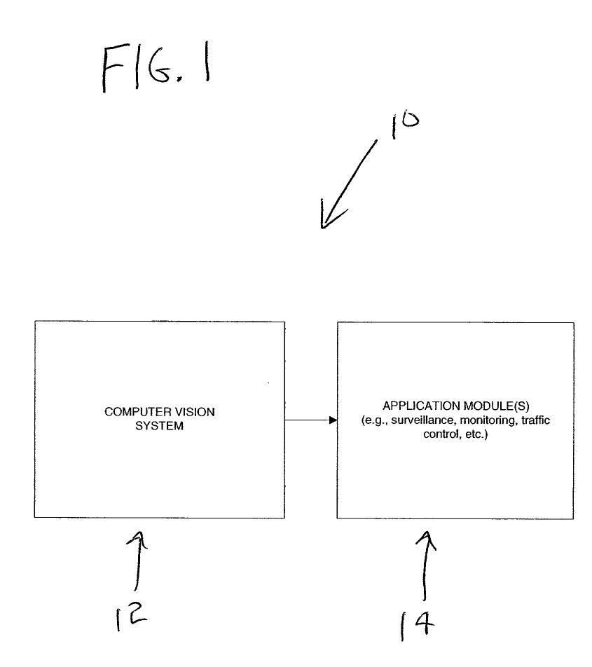

FIG. 1 is a general block diagram of a monitoring/detection system including a computer vision system and an application module operable for using output from the computer vision system according to the present invention.

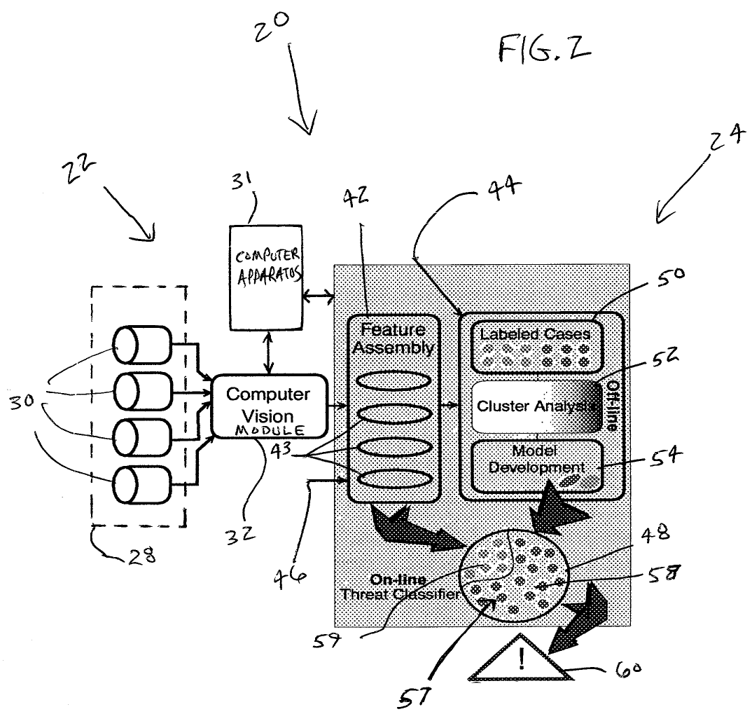

FIG. 2 is a general block diagram of a surveillance system including a computer vision system and an assessment module according to the present invention.

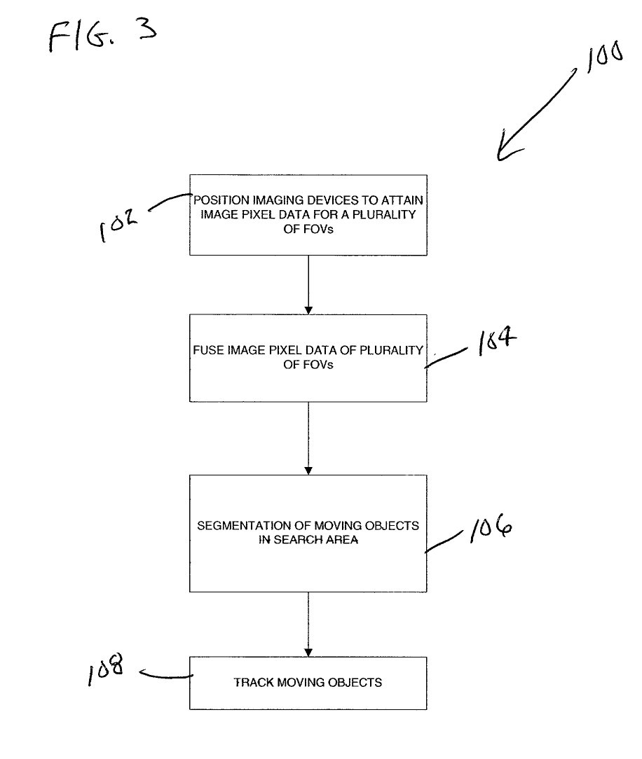

FIG. 3 is a generalized flow diagram of an illustrative embodiment of a computer vision method that may be carried out by the computer vision system shown generally in FIG. 2.

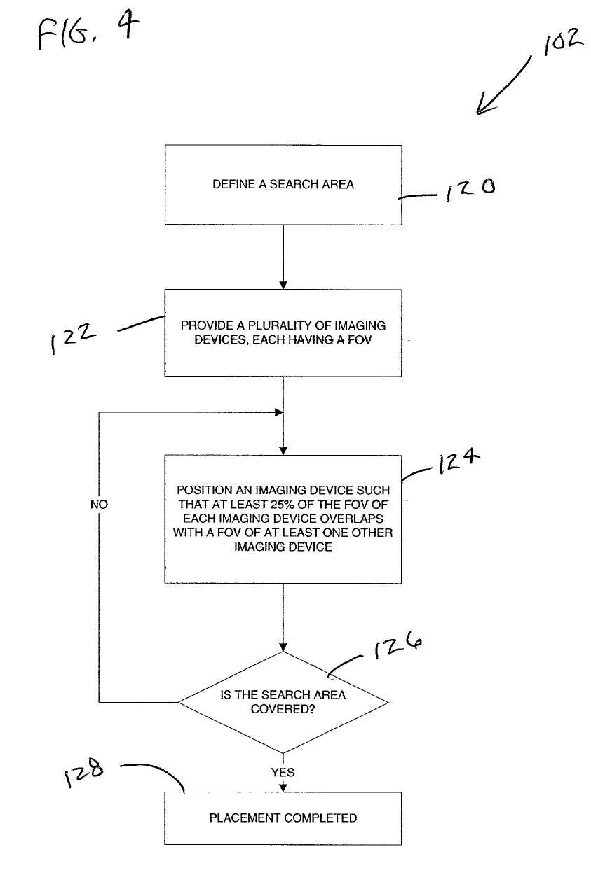

FIG. 4 is a flow diagram showing one illustrative embodiment of an optical system design process shown generally in FIG. 3.

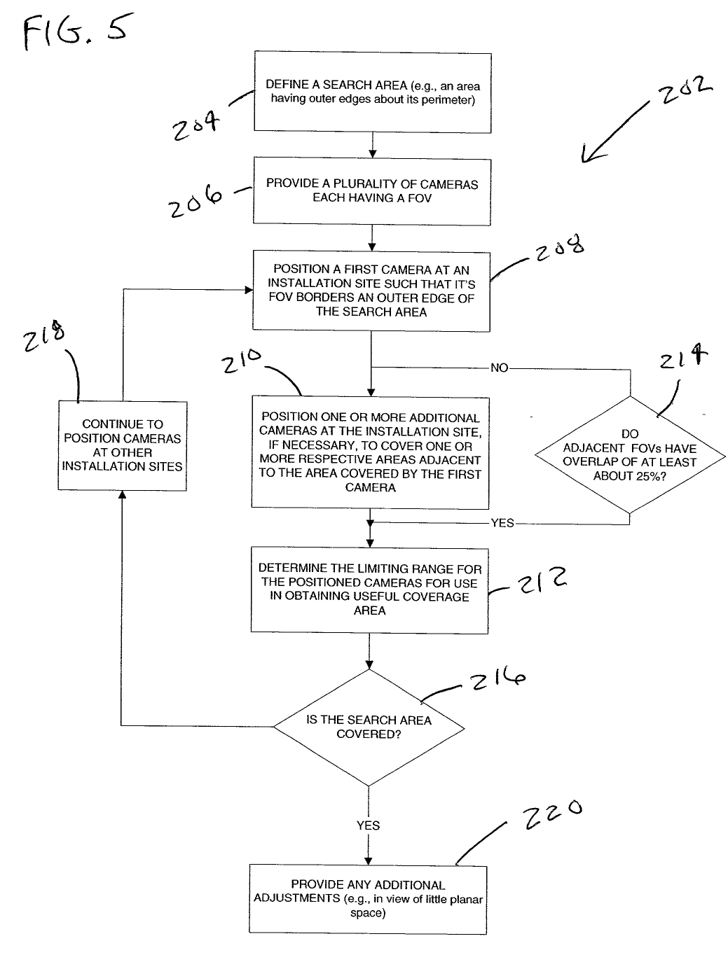

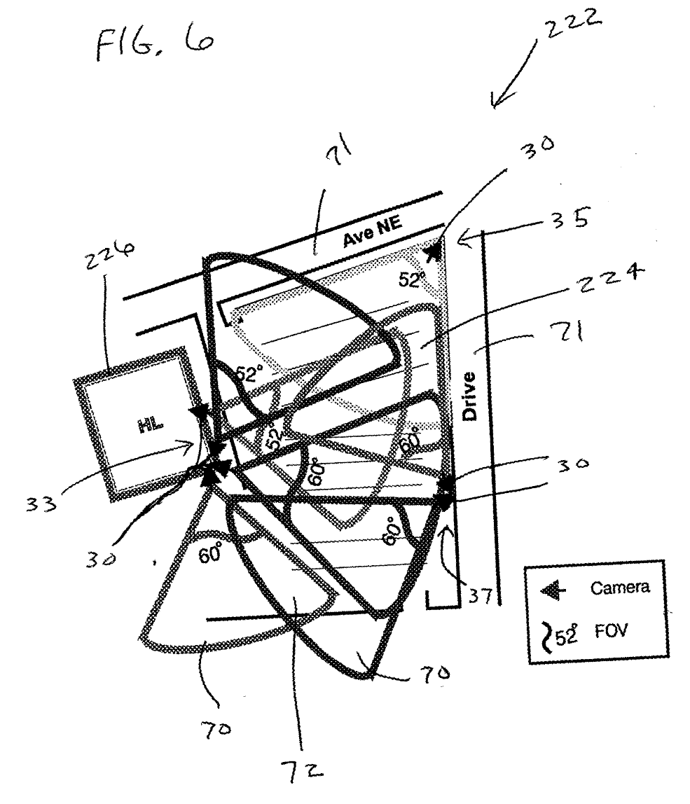

FIG. 5 shows a flow diagram of a more detailed illustrative embodiment of an optical system design process shown generally in FIG. FIG. 6 is an illustrative diagram of an optical system layout for use in describing the design process shown generally in FIG. 5.

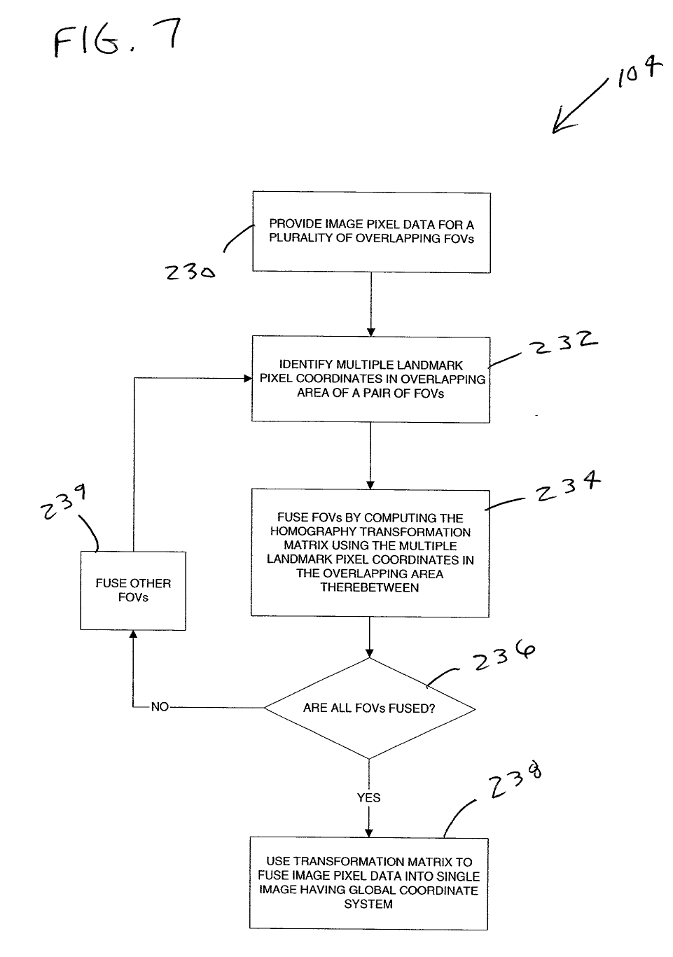

FIG. 7 shows a flow diagram of an illustrative embodiment of an image fusing method shown generally as part of the computer vision method of FIG. 3.

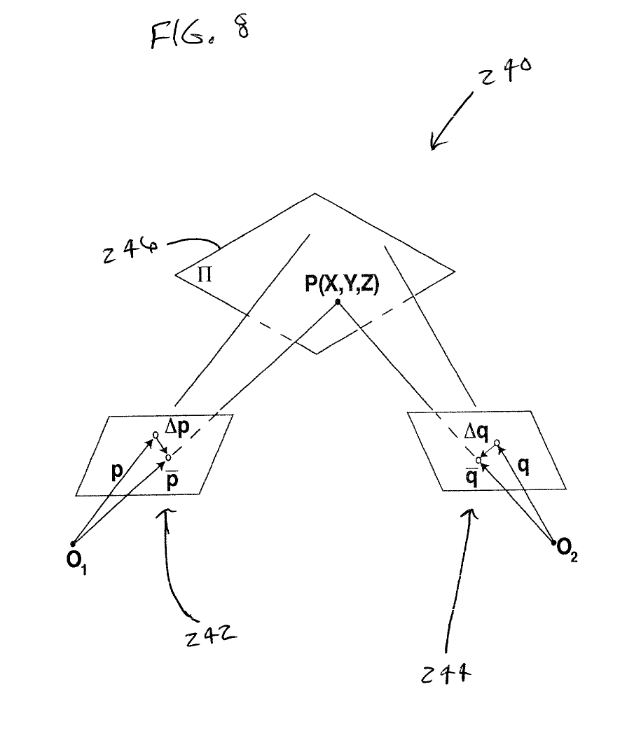

FIG. 8 is a diagram for use in describing the image fusing method shown generally in FIG. 7.

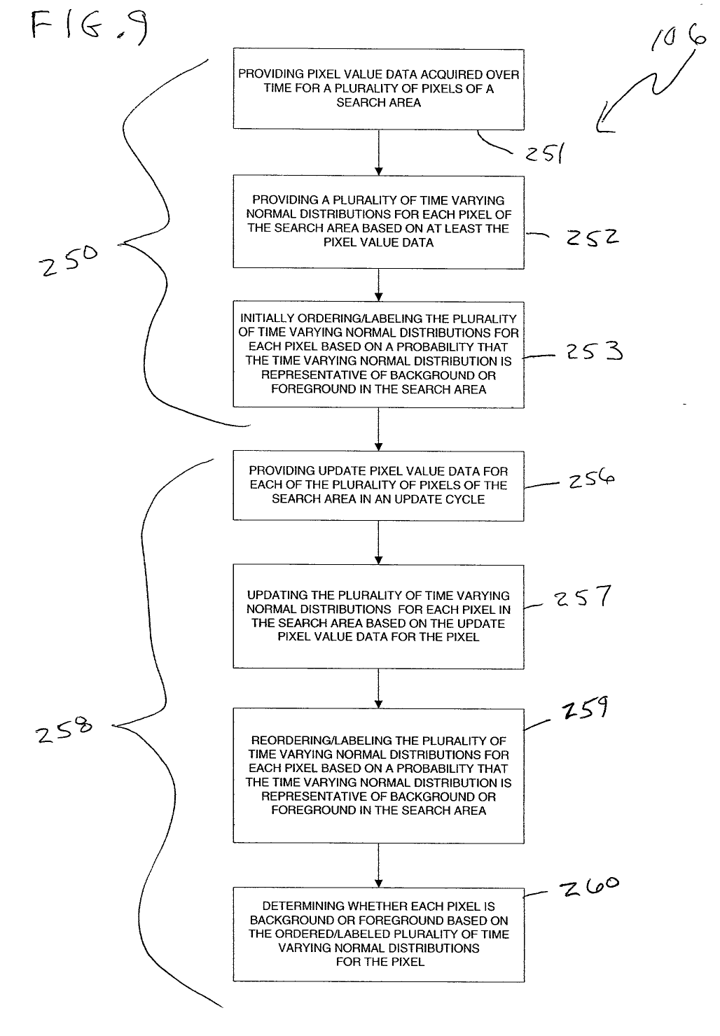

FIG. 9 shows a flow diagram of one illustrative embodiment of a segmentation process shown generally as part of the computer vision method of FIG. 3.

FIG. 10 is a diagrammatic illustration for use in describing the segmentation process shown in FIG. 9.

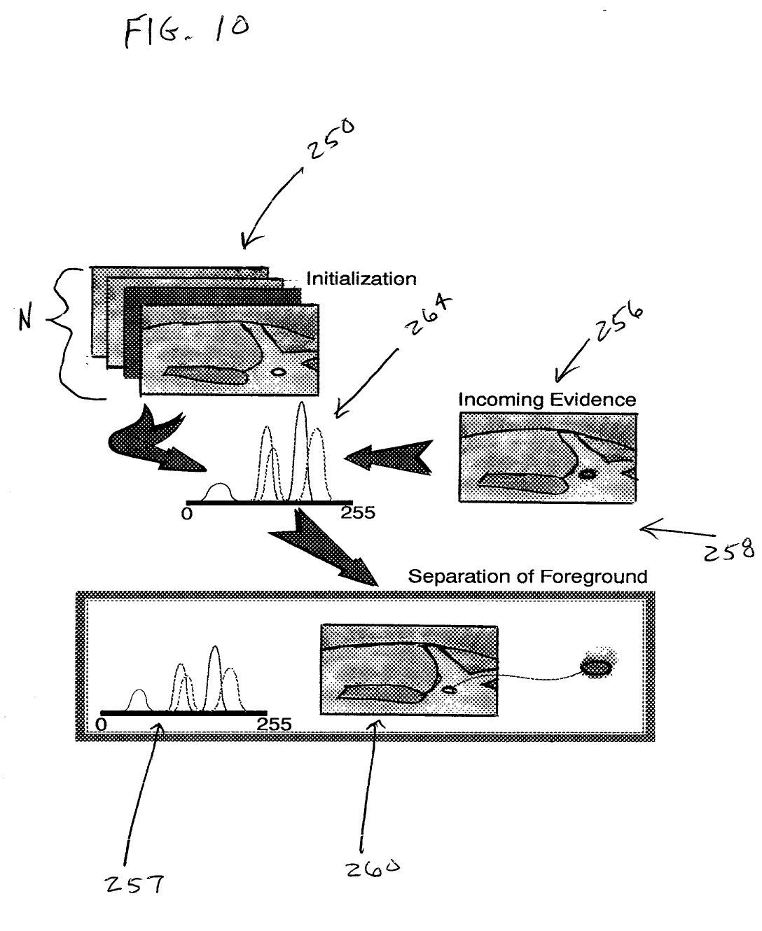

FIG. 11 is a diagram illustrating a plurality of time varying normal distributions for a pixel according to the present invention and as described with reference to FIG. 9.

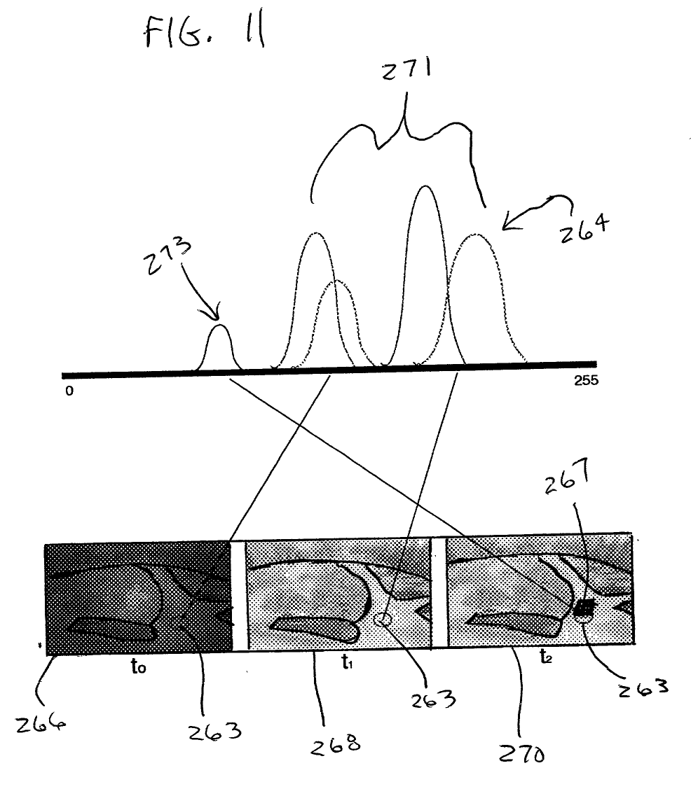

FIG. 12A illustrates the ordering of a plurality of time varying normal distributions and matching update data to the plurality of time varying normal distributions according to the present invention and as described with reference to FIG. 9.

FIG. 12B is a prior art method of matching update data to a plurality of time varying normal distributions.

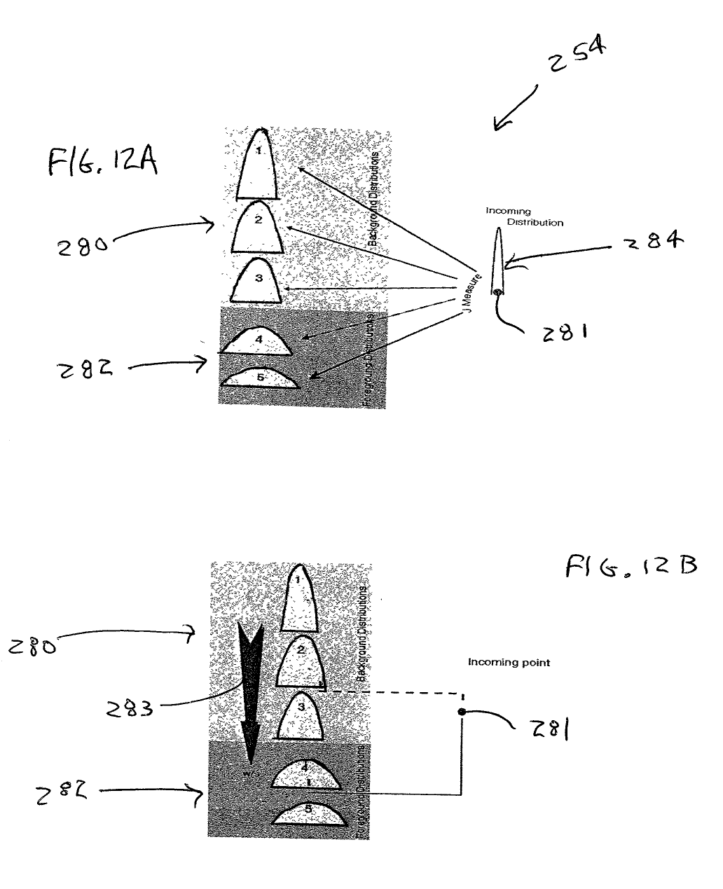

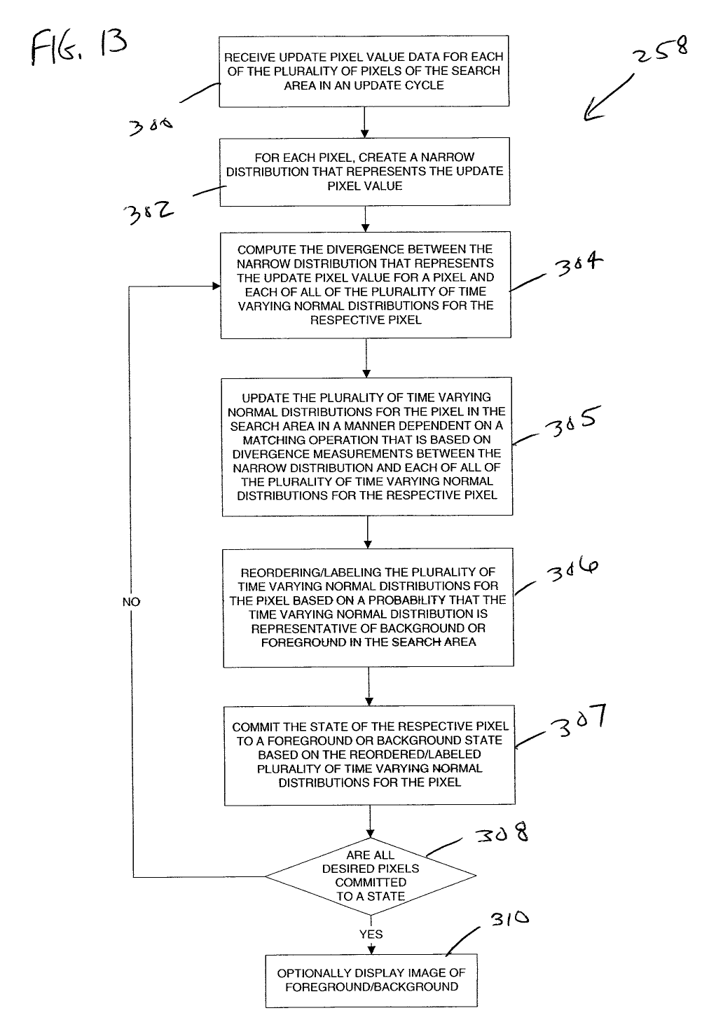

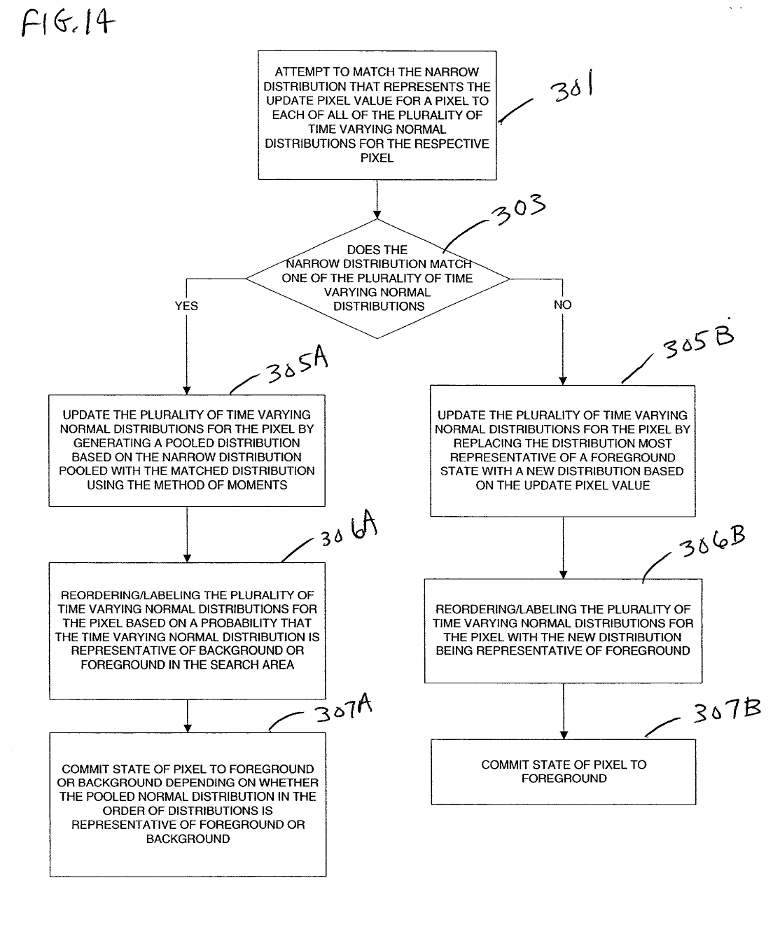

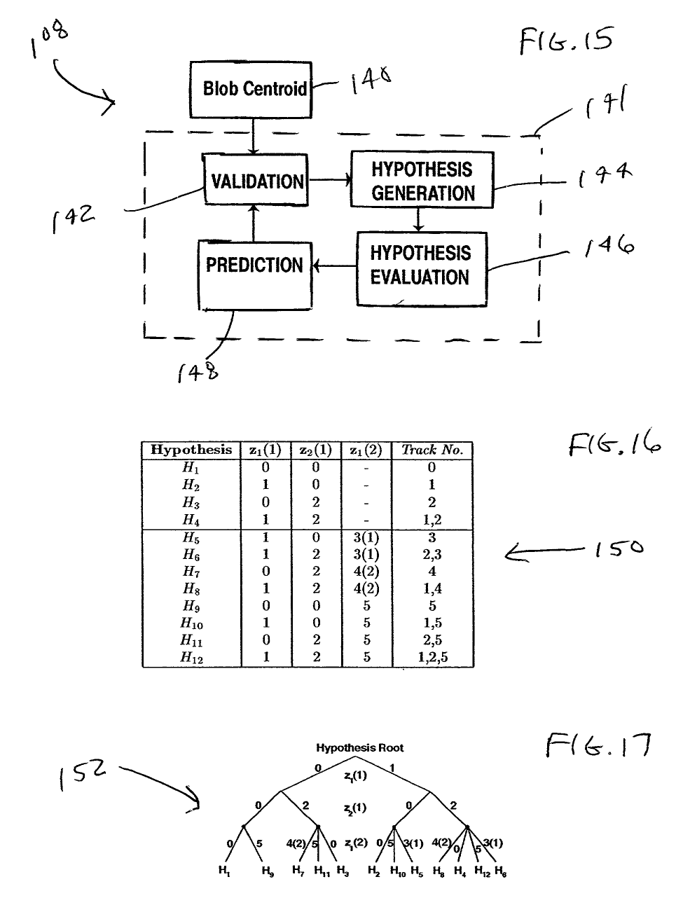

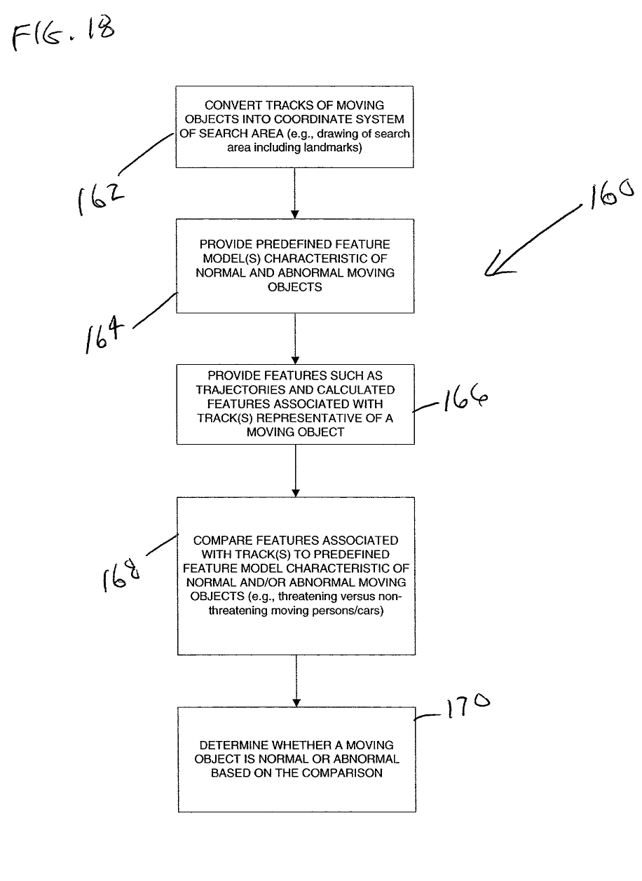

FIG. 13 shows a flow diagram illustrating one embodiment of an update cycle in the segmentation process as shown in FIG. 9.

FIG. 14 is a more detailed flow diagram of one illustrative embodiment of a portion of the update cycle shown in FIG. 13.

FIG. 15 is a block diagram showing an illustrative embodiment of a moving object tracking method shown generally in FIG. 3.

FIGS. 16 and 17 are diagrams for use in describing a preferred tracking method according to the present invention.

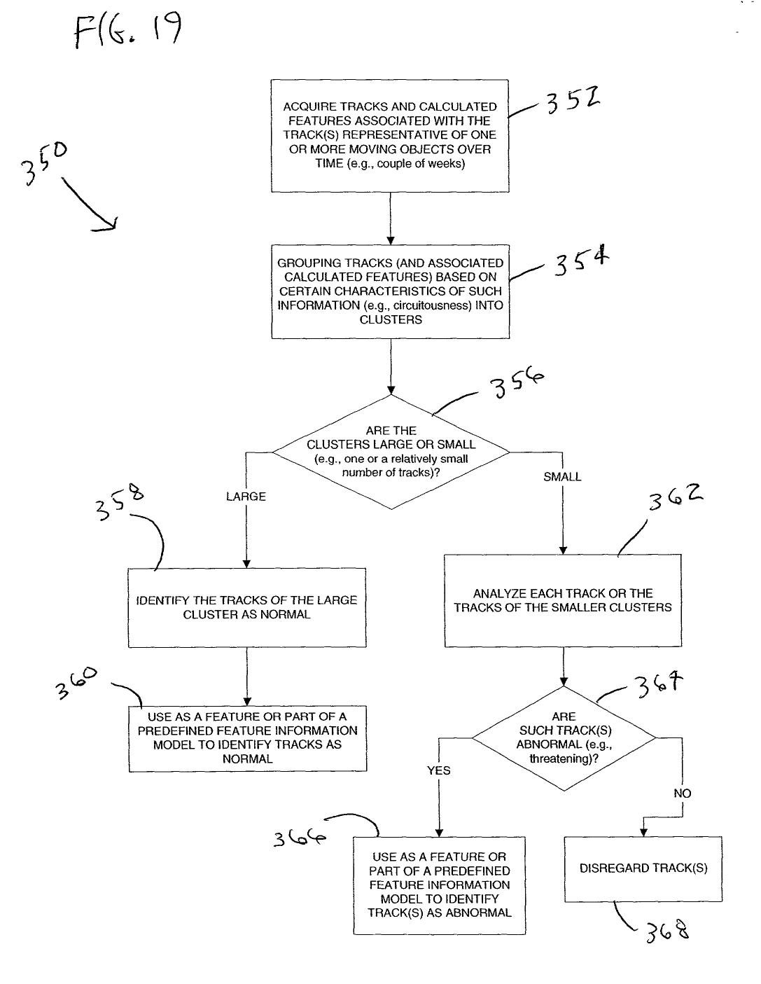

FIG. 18 is a flow diagram showing a more detailed illustrative embodiment of an assessment method illustrated generally in FIG. 2 with the assessment module of the surveillance system shown therein.

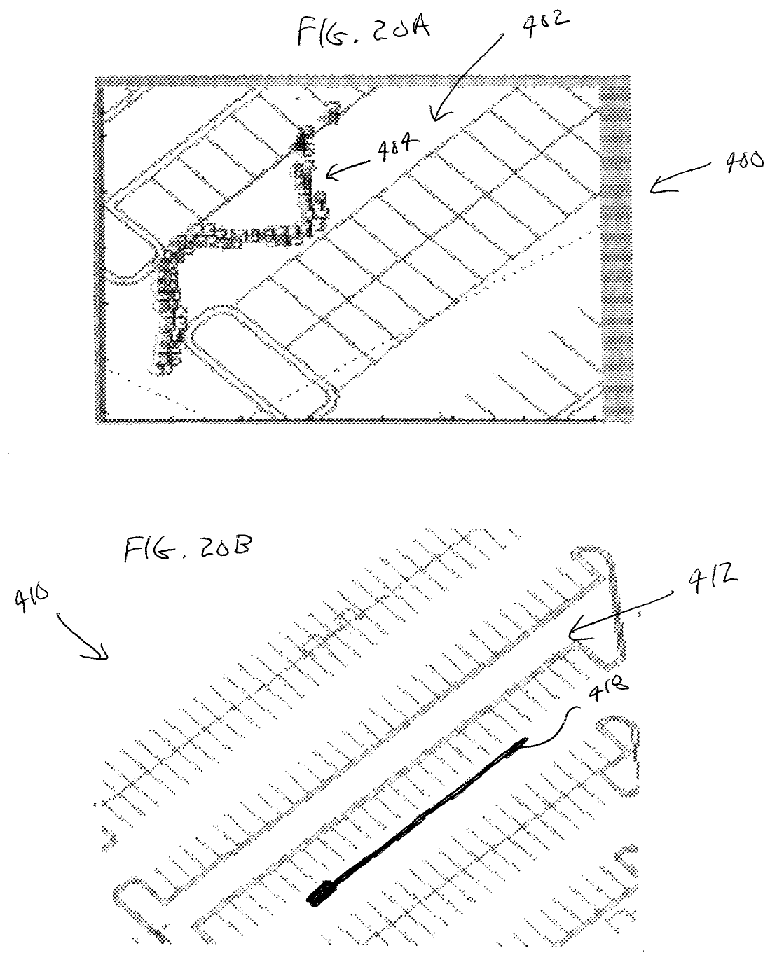

FIG. 19 shows a flow diagram illustrating one embodiment of a clustering process that may be employed to assist the assessment method shown generally in FIG. 18.

FIGS. 20A and 20B show threatening and non-threatening object paths, respectively, in illustrations that may be displayed according to the present invention.

### DETAILED DESCRIPTION OF THE EMBODIMENTS

Various systems and methods according to the present invention shall be described with reference to FIGS. 1-20. Generally, the present invention provides a monitoring/detection system 10 that generally includes a computer vision system 12 which provides data that can be used by one or more different types of application modules 14.

The present invention may be used for various purposes including, but clearly not limited to, a surveillance system (e.g., an urban surveillance system aimed for the security market). For example, such a surveillance system, and method associated therewith, are particularly beneficial in monitoring large open spaces and pinpointing irregular or suspicious activity patterns. For example, such a security system can fill the gap between currently available systems which report isolated events and an automated cooperating network capable of inferring and reporting threats, e.g., a Is function that currently is generally performed by humans.

The system 10 of the present invention includes a computer vision system 12 that is operable for tracking moving objects in a search area, e.g., the tracking of pedestrians and vehicles such as in a parking lot, and providing information associated with such moving objects to one or more application modules that are configured to receive and analyze such information. For example, in a surveillance system as shown generally and described with reference to FIG. 2, the computer vision system may provide for the reporting of certain features, e.g., annotated trajectories or moving object paths, to a threat assessment module for evaluation of the reported data, e.g., analysis of whether the object path is normal or abnormal, whether the object path is characteristic of a potential threatening or non-threatening event such as a burglar or terrorist, etc.

It is noted that various distinct portions of the systems and methods as described herein may be used either separately or together as a combination to form an embodiment of a system or method. For example, the computer vision system 12 is implemented in a manner such that the information generated thereby may be used by one or more application modules 14 for various purposes, beyond the security domain. For example, traffic statistics gathered using the computer vision system 12 may be used by an application module 14 for the benefit of building operations.

One such exemplary use would be to use the traffic statistics to provide insight into parking lot utilization during different times and days of the year. Such insight may support a functional redesign of the open space being monitored (e.g., a parking lot, a street, a parking garage, a pedestrian mall, etc.) to better facilitate transportation and safety needs.

Further, for example, such data may be used in a module 14 for traffic pattern analysis, pedestrian analysis, target identification, and/or any other type of object recognition and/or tracking applications. For example, another application may include provision of itinerary statistics of department store customers for marketing purposes.

In addition, for example, a threat assessment module of the present invention may be used separately with data provided by a totally separate and distinct data acquisition system, e.g., a data acquisition other than a computer vision system. For example, the threat assessment module may be utilized with any other type of system that may be capable of providing object paths of a moving object in a search area, or other information associated therewith, such as a radar system (e.g., providing aircraft patterns, providing bird traffic, etc.), a thermal imaging system (e.g., providing tracks for humans detected thereby), etc.

As used herein, a search area may be any region being monitored according to the present invention. Such a search area is not limited to any particular area and may include any known object therein. For example, such search areas may be indoor or outdoor, may be illuminated or non-illuminated, may be on the ground or in the air, etc. Various illustrative examples of search areas may include defined areas such as a room, a parking garage, a parking lot, a lobby, a bank, a region of air space, a playground, a pedestrian mall, etc.

As used herein, a moving object refers to anything, living or non-living that can change location in a search area. For example, moving objects may include people (e.g., pedestrians, customers, etc.), planes, cars, bicycles, animals, etc.

In one illustrative embodiment of the monitoring/detection system 10, shown generally in FIG. 1, the monitoring/detection system 10 is employed as a surveillance system 20 as shown in FIG. 2. The surveillance system 20 includes a computer vision system 22 which acquires image data of a search area, e.g., a scene, and processes such image data to identify moving objects, e.g., foreground data, therein. The moving objects are tracked to provide object paths or trajectories as at least a part of image data provided to an assessment module 24, e.g., a threat assessment module.

Generally, the computer vision system 22 includes an optical design 28 that provides for coverage of at least a portion of the search area, and preferably, an entire defined search area bounded by an outer perimeter edge, using a plurality of imaging devices 30, e.g., visible band cameras. Each of the plurality of imaging devices provide image pixel data for a corresponding field of view (FOV) to one or more computer processing apparatus 31 capable of operating on the image pixel data to implement one or more routines of computer vision software module 32.

Generally, as shown in computer vision method 100 of FIG. 3, upon positioning of imaging devices to attain image pixel data for a plurality of fields of view within the search area (block 102), the computer vision module 32 operates upon such image pixel data to fuse image pixel data of the plurality of fields of view of the plurality of imaging devices (e.g., fields of view in varying local coordinate systems) to attain image data representative of a single image (block 104), e.g., a composite image in a global coordinate system formed from the various fields of view of the plurality of imaging devices.

Thereafter, the single image may be segmented into foreground and background so as to determine moving objects (e.g., foreground pixels) in the search area (block 106). Such moving objects can then be tracked to provide moving object paths or trajectories, and related information (e.g., calculated information such as length of object path, time of moving object being detected, etc.) (block 108).

Preferably, the optical design 28 includes the specification of an arrangement of imaging devices that optimally covers the defined search area. The optical system design also includes the specification of the computational resources necessary to run computer vision algorithms in real-time. Such algorithms include those necessary as described above, to fuse images, provide for segmentation of foreground versus background information, tracking, etc. Further, the optimal system design includes display hardware and software for relaying information to a user of a system. For example, computer vision algorithms require substantial computational power for full coverage of the search area. As such, at least mid-end processors, e.g., those 500 MHz processors, are preferably used to carry out such algorithms.

Preferably, off-the-shelf hardware and software development components are used and an open architecture strategy is allowed. For example, off-the-shelf personal computers, cameras, and non-embedded software tools are used.

For example, the computing apparatus 31 may be one or more processor based systems, or other specialized hardware used for carrying out the computer vision algorithms and/or assessment algorithms according to the present invention. The computing apparatus 31 may be, for example, one or more fixed or mobile computer systems, e.g., a personal computer. The exact configuration of the computer system is not limiting and most any device or devices capable of providing suitable computing capabilities may be used according to the present invention. Further, various peripheral devices, such as a computer display, a mouse, a keyboard, a printer, etc., are contemplated to be used in combination with a processor of the computing apparatus 31. The computer apparatus used to implement the computer vision algorithms may be the same as or different from the apparatus used to perform assessment of the feature data resulting therefrom, e.g., threat assessment.

In one preferred embodiment of the computer vision method 100, which will be described in further detail below, the present invention preferably performs moving object segmentation through multi-normal representation at the pixel level. The segmentation method is similar to that described in C. Stauffer and W. E. L. Grimson, “Learning patterns of activity using real-time tracking,” IEEE Transactions on Pattern Analysis and Machine Intelligence, vol. 22, no. 8, pp. 747-767, 2000, and in C. Stauffer and W. E. L. Grimson, “Adaptive background mixture models for real-time tracking,” in Proceedings 1999 IEEE Conference on Computer Vision and Pattern Recognition, vol. 2, pp. 246-252, Fort Collins, Colo. (Jun. 23-25, 1999), with various advantageous modifications. The method identifies foreground pixels in each new frame of image data while updating the description of each pixel's mixture model.

The labeled or identified foreground pixels can then be assembled into objects, preferably using a connected components algorithm. Establishing correspondence of objects between frames (i.e., tracking) is preferably accomplished using a linearly predictive multiple hypotheses tracking algorithm which incorporates both position and size.

Since no single imaging device, e.g., camera, is able to cover large open spaces, like parking lots, in their entirety, the fields of view of the various cameras are fused into a coherent single image to maintain global awareness. Such fusion (or commonly referred to as calibration) of multiple imaging devices, e.g., cameras, is accomplished preferably by computing homography matrices. The computation is based on the identification of several landmark points in the common overlapping field of view regions between camera pairs.

Preferably, the threat assessment module 24 comprises a feature assembly module 42 followed by a threat classifier 48. The feature assembly module 42 extracts various security relevant statistics from object paths, i.e., object tracks, or groups of paths. The threat classifier 48 determines, preferably in real-time, whether a particular object path, e.g., a moving object in the featured search area, constitutes a threat. The threat classifier 48 may be assisted by a threat modeling training module 44 which may be used to define threatening versus non-threatening object paths or object path information associated with threatening or non-threatening events.

With further reference to the Figures, the present invention may be used with any number of different optical imaging designs 28 (see FIG. 2) as generally shown by the positioning of image devices (block 102) in the computer vision method of FIG. 3. However, preferably the present invention provides an optical design 28 wherein a plurality of imaging devices 30 are deliberately positioned to obtain advantages over other multi-imaging device systems. The preferable camera positioning design according to the present invention ensures full coverage of the open space being monitored to prevent blind spots that may cause the threat of a security breach.

Although video sensors and computational power for processing data from a plurality of image devices are getting cheaper and therefore can be employed in mass to provide coverage for an open space, most cheap video sensors do not have the required resolution to accommodate high quality object tracking. Therefore, video imagers for high end surveillance applications are still moderately expensive, and thus, reducing the number of imaging devices provides for a substantial reduction of the system cost. Preferably, the cameras used are weatherproof for employment in outdoor areas. However, this leads to additional cost.

Further, installation cost that includes the provision of power and the transmission of video signals, sometimes at significant distances from the processing equipment, also dictates the need to provide a system with a minimal quantity of cameras being used. For example, the installation cost for each camera is usually a figure many times the camera's original value.

Further, there may also be restrictions on the number of cameras used due to the topography of the area (e.g., streets, tree lines) and due to other reasons, for example, city and building ordinances (e.g., aesthetics).

In summary, in view of the considerations described above, preferably the allowable number of cameras for a surveillance system is kept to a minimum. Further, other optical system design considerations may include the type of computational resources, the computer network bandwidth, and the display capabilities associated with the system.

Preferably, the optical design 28 is provided by selectively positioning imaging devices 30, as generally shown in block 102 of FIG. 3, and in a further more detailed illustrative embodiment of providing such an optical design 28 as shown in FIG. 4. It will be recognized that optical design as used herein refers to both actual physical placement of imaging devices as well as simulating and presenting a design plan for such imaging devices.

The optical design process (block 102) is initiated by first defining the search area (block 120). For example, the search area as previously described herein may include any of a variety of regions to be monitored such as a parking lot, a lobby, a roadway, a portion of air space, etc.

A plurality of imaging devices are provided for use in covering the defined search area (block 122). Each of the plurality of imaging devices has a field of view and provides image pixel data representative thereof as described further below.

The plurality of imaging devices may include any type of camera capable of providing image pixel data for use in the present invention. For example, single or dual channel camera systems may be used. Preferably, a dual channel camera system is used that functions as a medium-resolution color camera during the day and as a high-resolution grayscale camera during the night. Switching from day to night operations is controlled automatically through a photosensor. The dual channel technology capitalizes upon the fact that color information in low light conditions at night is lost. Therefore, there is no reason for employing color cameras during night time conditions. Instead, cheaper and higher resolution grayscale cameras can be used to compensate for the loss of color information.

For example, the imaging devices may be DSE DS-5000 dual channel systems available from Detection Systems and Engineering (Troy, Mich.). The color day camera has a resolution of H_{d}=480 lines per frame. The grayscale night camera has a resolution of Hₙ=570 lines per frame. The DSE DS-5000 camera system has a 2.8-6 millimeter f/1.4 vari-focal auto iris lens for both day and night cameras. This permits variation of the field of view of the cameras in the range of 44.4 degrees to 82.4 degrees.

For design consideration, a field of view is selected which is suitable for use in performing necessary calculations. For example, an intermediate value of FOV=60 degrees may be selected for such calculations. To satisfy the overlapping constraints as further described below, an increase or decrease of the FOV of one or more of the cameras from this value can be made.

Preferably, the optical design 28 provides coverage for the entire defined search area, e.g., a parking lot, air space, etc., with a minimum number of cameras to decrease cost as described above. However, in many circumstances the installation space to position the cameras is limited by the topography of the search area. For example, one cannot place a camera pole in the middle of the road. However, existing poles and rooftops can be used to the extent possible.

In view of such topography considerations, one can delineate various possible camera installation sites in a computer-aided design of the defined search area. However, the installation search space is further reduced by constraints imposed thereon by the computer vision algorithms. For example, an urban surveillance system may be monitoring two kinds of objects: vehicles and people. In terms of size, people are the smallest objects under surveillance. Therefore, their footprint should drive the requirements for the limiting range of the cameras as further described below. Such limiting range is at least in part based on the smallest object being monitored. In turn, the determination of the limiting range assists in verifying if there is any space in the parking lot that is not covered under any given camera configuration.

Preferably, each imaging device, e.g., camera, has an overlapping field of view with at least one other imaging device. The overlapping arrangement is preferably configured so that transition from one camera to the other through indexing of the overlapped areas is easily accomplished and all cameras can be visited in a unidirectional trip without encountering any discontinuity. Such indexing allows for the fusing of a field of view of an imaging device with fields of view of other imaging devices already fused in an effective manner as further described below.

The overlap in the fields of view should be preferably greater than 25 percent, and more preferably greater than 35 percent. Further, such overlap is preferably less than 85 percent so as to provide effective use of the camera's available field of use, and preferably less than 50 percent. Such percentage requirements allow for the multi-camera calibration algorithm (i.e., fusion algorithm) to perform reliably. This percent of overlap is required to obtain several well spread landmark points in the common field of view for accurate homography. For example, usually, portions of the overlapping area cannot be utilized for landmarking because it is covered by non-planar structures, e.g., tree lines. Therefore, the common area between two cameras may be required to cover as much as half of the individual fields of view.

Therefore, as shown in FIG. 4, each imaging device is positioned such that at least 25% of the field of view of each imaging device overlaps with the field of view of at least one other imaging device (block 124). If the search area is covered by the positioned imaging devices, then placement of the arrangement of imaging devices is completed (block 128). However, if the search area is not yet completely covered (block 126), then additional imaging devices are positioned (block 124).

A more detailed illustrative camera placement process 202 is shown in FIG. 5. In the camera placement algorithm or process 202, the search area is defined (block 204). For example, the search area may be defined by an area having a perimeter outer edge. One illustrative example where a parking lot 224 is defined as the search area is shown in FIG. 6. As illustrated, the streets 71 act as at least a portion of the perimeter outer edge.

Further, a plurality of cameras each having a field of view are provided for positioning in further accordance with the camera placement algorithm or process (block 206). First, at one installation site, an initial camera is placed in such a way that its field of view borders at least a part of the perimeter outer edge of the search area (block 208). In other words, the field of view covers a region along at least a portion of the perimeter outer edge.

Thereafter, cameras are added around the initial camera at the initial installation site, if necessary, to cover regions adjacent to the area covered by the initial camera (block 210). For example, cameras can be placed until another portion of the perimeter outer edge is reached. An illustration of such coverage is provided in FIG. 6. As shown therein, the initial camera is placed at installation site 33 to cover a region at the perimeter outer edge at the bottom of the diagram and cameras continue to be placed until the cameras cover the region along the perimeter edge at the top of the diagram, e.g., street 71 adjacent the parking lot.

When each camera is placed, the amount of overlap must be determined. Preferably, it should be confirmed that at least about 25 percent overlap of the neighboring fields of view is attained (block 214). Further, the limiting range is computed for each of the installed cameras (block 212). By knowing the field of view and the limiting range, the full useful coverage area for each camera is attained as further described below. In view thereof, adjustments can be made to the position of the cameras or to the camera's field of view.

After completion of the positioning of cameras at the first installation site, it is determined whether the entire search area is cover (block 216). If the search area is covered, then any final adjustments are made (block 220) such as may be needed for topography constraints, e.g., due to limited planar space.

If the entire search area is not covered, then cameras are positioned in a like manner at one or more other installation sites (block 218). For example, such cameras are continued to be placed at a next installation site that is just outside of the area covered by the cameras at the first installation site. However, at least one field of view of the additional cameras at the additional installation site preferably overlaps at least 25 percent with one of the fields of view of a camera at the initial installation site. The use of additional installation sites is repeated until the entire search area is covered.

Various other post-placement adjustments may be needed as alluded to above (block 220). These typically involve the increase or reduction of the field of view for one or more of the cameras. The field of view adjustment is meant to either trim some excessive overlapping or add some extra overlapping in areas where there is little planar space (e.g., there are a lot of trees).

Particularly, computation of the camera's limiting range R_{c} is used to assist in making such adjustments. It is computed from the equation:

$${R}_{c} = \frac{{P}_{f}}{tan ( IFOV )} ,$$

where P_{f} is the smallest acceptable pixel footprint of an object being monitored, e.g., a human, and IFOV is the instantaneous field of view.

For example, the signature of the human body preferably should not become smaller than a w×h=3×9=27 pixel rectangle on the focal plane array (FPA). Clusters with fewer than 27 pixels are likely to be below the noise level. If we assume that the width of an average person is about Wₚ=24 inches, then the pixel footprint P_{f}=24/3=8. The IFOV is computed from the following formula:

$$IFOV = \frac{FOV}{{L}_{FPA}} ,$$

where L_{FPA} is the resolution for the camera.

For example, with a FOV=60 degrees and L_{FPA}=480 pixels (color day camera), the limiting range is R_{c}=305 feet. For FOV=60 degrees and L_{FPA}=570 pixels (grayscale night camera), the limiting range is R_{c}=362 feet. In other words, between two cameras with the same FOV, the higher resolution camera has larger useful range. Conversely, if two cameras have the same resolution, then the one with the smaller FOV has larger useful range. As such, during post-placement adjustments (block 220), a camera's field of view can be reduced, e.g., from a FOV of 60 degrees to a FOV=52 degrees in some of the lower resolution day camera channels, to increase their effective range limit.

The optical design 28 is important to the effectiveness of the surveillance system 20. The principles, algorithms, and computations used for the optical design can be automated for use in providing an optical design for imaging devices in any other defined search area, e.g., parking lot or open area.

At least a portion of one illustrative optical design 222 is shown in FIG. 6. Seven cameras are positioned to entirely cover the search area 224, which is a parking lot defined at least in part by streets 71 and building 226.

Each camera may have a dedicated standard personal computer for processing information, with one of the personal computers being designated as a server where fusion of image pixel data from all seven cameras, as further described below, may be performed. One skilled in the art will recognize that any computer set-up may be utilized, with all the processing actually being performed by a single or multiple computer system having sufficient computational power.

As shown in FIG. 6, coverage is provided by cameras 30 positioned at three installation sites 33, 35, and 37. For simplicity, four cameras 30 are positioned at first installation site 33, an additional camera 30 is positioned at installation site 35, and two other additional cameras 30 are positioned at a third installation site 37. With the fields of view 70 as indicated in FIG. 6, and with at least a 25% overlap 72 between the fields of view 70 of one camera 30 relative to another, the entire parking lot 224 may be imaged.

In further reference to FIG. 3, with the imaging devices 30 positioned to obtain image pixel data for the plurality of fields of view, the image pixel data is preferably fused (block 104). The fused image information may be displayed, for example, along with any annotations (e.g., information regarding the image such as the time at which the image was acquired), on any display allowing a user to attain instant awareness without the distraction of multiple fragmented views. One illustrative embodiment of an image fusing method 104 is shown in the diagram of FIG. 7.

As shown in FIG. 7, image pixel data for a plurality of overlapping fields of view is provided (block 230). Generally, monitoring of large search areas can only be accomplished through the coordinated use of multiple camera imaging devices. Preferably, a seamless tracking of humans and vehicles across the whole geographical search area covered by all the imaging devices is desired. To produce the single image of the search area, the fields of view of the individual imaging devices having local coordinate systems must be fused or otherwise combined to a global coordinate system. Then, an object path of a moving object can be registered against the global coordinate system as opposed to multiple fragmented views.

To achieve multiple imaging device registration or fusion (also commonly referred to as calibration), a homography transformation is computed for a first pair of imaging devices. Thereafter, a homography computation is performed to add a field of view of an additional imaging device to the previously computed homography transformation. This procedure takes advantage of the overlapping portions that exist between the fields of view of pairs of neighboring imaging devices. Further, since preferably, the fields of view are set up so that one can index through the fields of view of one imaging device to the next and so forth as previously described herein, then the additional imaging devices are continually added to the homography transformation in an orderly and effective manner.

In other words, a first homography transformation matrix is computed for a first and second imaging device having overlapping portions. This results in a global coordinate system for both the first and second imaging devices. Thereafter, a third imaging device that overlaps with the second imaging device is fused to the first and second imaging devices by computing a homography transformation matrix using the landmark points in the overlapping portion of the fields of view of the second and third imaging devices in addition to the homography matrix computed for the first and second imaging devices. This results in a homography transformation for all three imaging devices, i.e., the first, second, and third imaging devices, or in other words, a global coordinate system for all three imaging devices. The process is continued until all the imaging devices have been added to obtain a single global coordinate system for all of the imaging devices.

Multiple landmark pixel coordinates in overlapping portions of a pair of fields of view for a pair of imaging devices are identified (block 232) for use in computing a homography transformation for the imaging devices (block 234). The pixel coordinates of at least four points in the overlapping portions are used when an imaging device is fused to one or more other imaging devices (block 234).

The points in the overlapping portions are projections of physical ground plane points that fall in the overlapping portion between the fields of view of the two imaging devices for which a matrix is being computed. These points are selected and physically marked on the ground during installation of the imaging devices 30. Thereafter, the corresponding projected image points can be sampled through a graphical user interface by a user so that they can be used in computing the transformation matrix.

This physical marking process is only required at the beginning of the optical design 28 installation. Once imaging device cross registration is complete, it does not need to be repeated.

The homography computation may be performed by any known method. One method for computing the homography transformation matrices is a so-called least squares method, as described in L. Lee, R. Romano, and G. Stein, “Monitoring activities from multiple video streams: Establishing a common coordinate frame,” IEEE Transactions on Pattern Analysis and Machine Intelligence, vol. 22, no. 8, pp. 758-767 (2000). However, although usable, this method typically provides poor solution to the underconstrained system of equations due to biased estimation. Further, it may not be able to effectively specialize the general homography computation when special cases are at hand.

Preferably, an algorithm, as described in K. Kanatani, “Optimal homography computation with a reliability measure,” in Proceedings of the IAPR Workshop on Machine Vision Applications, Makuhari, Chiba, Japan, pp. 426-429 (November 1998), is used to compute the homography matrices. This algorithm is based on a statistical optimization theory for geometric computer vision, as described in K. Kanatani, Statistical Optimization for Geometric Computer Vision: Theory and Practice, Elsevier Science, Amsterdam, Netherlands (1996) This algorithm appears to cure the deficiencies exhibited by the least squares method.

The basic premise of the algorithm described in Kanatani is that the epipolar constraint may be violated by various noise sources due to the statistical nature of the imaging problem. As shown in the illustration 240 of FIG. 8, the statistical nature of the imaging problem affects the epipolar constraint. O₁ and O₂ are the optical centers of the corresponding imaging devices 242 and 244. P(X,Y,Z) is a point in the search area that falls in the common area 246, i.e., the overlapping portion, between the two fields of view of the pair of imaging devices. Ideally, the vectors

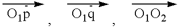

are coplanar. Due to the noisy imaging process, however, the actual vectors

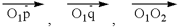

may not be coplanar. As homography transformation computations are known in the art, the information provided herein has been simplified. Further information may be obtained from R. Hartley and A. Zisserman, Multiple View Geometry in Computer Vision, Cambridge University Press, pp. 69-112, (2000).

The homography transformation is computed to fuse all of the FOVs of the imaging devices as described above and as shown by the decision block 236 and loop block 239. As shown therein, if all the FOVs have not been fused, then additional FOVs should be fused (block 239). Once all the FOVs have been registered to the others, the homography transformation matrices are used to fuse image pixel data into a single image of a global coordinate system (block 238).

Such fusion of the image pixel data of the various imaging devices is possible because the homography transformation matrix describes completely the relationship between the points of one field of view and points of another field of view for a corresponding pair of imaging devices. Such fusion may also be referred to as calibration of the imaging devices.

The pixels of the various fields of view are provided at coordinates of the global coordinate system. Where pixels exist for a particular set of coordinates, an averaging technique is used to provide the pixel value for the particular set of coordinates. For example, such averaging would be used when assigning pixel values for the overlapping portions of the fields of view. Preferably, comparable cameras are used in the system such that the pixel values for a particular set of coordinates in the overlapping portions from each of the cameras are similar.

With further reference to FIG. 3, once the image pixel data is fused for the plurality of fields of view (block 104), segmentation of moving objects in the search area is performed (block 106), e.g., foreground information is segmented from background information. Any one of a variety of moving object segmenters may be used. However, as further described below, a method using a plurality of time varying normal distributions for each pixel of the image is preferred.

Two conventional approaches that may be used for moving object segmentation with respect to a static camera include temporal differencing, as described in C. H. Anderson, P. J. Burt, and G. S. Van Der Wal, “Change detection and tracking using pyramid transform techniques,” Proceedings of SPIE—the International Society for Optical Engineering, Cambridge, Mass., vol. 579, pp. 72-78, (Sep. 16-20, 1985), and background subtraction, as described in I. Haritaoglu, D. Harwood, and L. S. Davis, “W/sup 4/s: A real-time system for detecting and tracking people in 2 ½d,” Proceedings 5th European Conference on Computer Vision, Freiburg, Germany, vol. 1, pp. 877-892 (Jun. 2-6, 1998). Temporal differencing is very adaptive to dynamic environments, but may not provide an adequate job of extracting all the relevant object pixels. Background subtraction provides the most complete object data, but is extremely sensitive to dynamic scene changes due to lighting and extraneous events.

Other adaptive backgrounding methods are described in T. Kanade, R. T. Collins, A. J. Lipton, P. Burt, and L. Wixson, “Advances in cooperative multi-sensor video surveillance,” Proceedings DARPA Image Understanding Workshop, Monterey, Calif., pp. 3-24 (November 1998), and can cope much better with environmental dynamism. However, they may still be inadequate to handle bimodal backgrounds and have problems in scenes with many moving objects.

Stauffer et al. has described a more advanced object detection method based on a mixture of normals representation at the pixel level. This method features a far better adaptability and can handle bimodal backgrounds (e.g., swaying tree branches). The method provides a powerful representation scheme. Each normal of the mixture of normals for each pixel reflects the expectation that samples of the same scene point are likely to display Gaussian noise distributions. The mixture of normals reflects the expectation that more than one process may be observed over time. Further, A. Elgammal, D. Harwood, and L. Davis, “Non-parametric model for background subtraction,” Proceedings IEEE FRAME-RATE Workshop, Corfu, Greece, www.eecs.lehigh.edu/FRAME (September 2000) proposes a generalization of the normal mixture model, where density estimation is achieved through a normal kernel function.

In general, the mixture of normals paradigm produces suitable results in challenging outdoor conditions. It is the baseline algorithm for the preferred moving object segmenter according to the present invention. This method may be used according to one or more embodiments of the present invention in the form as described by Stauffer et al. or preferably modified as described herein.

Preferably, as indicated above, a segmentation process 106 similar to that described in Stauffer et al. is used according to the present invention. However, the process according to Stauffer is modified, as shall be further described below, particularly with reference to a comparison therebetween made in FIGS. 12A and 12B.

Generally, the segmentation process 106 as shown in both the flow diagram of FIG. 9 and the block diagram of FIG. 10 includes an initialization phase 250 which is used to provide statistical values for the pixels corresponding to the search area. Thereafter, incoming update pixel value data is received (block 256) and used in an update cycle phase 258 of the segmentation process 106.

As shown and described with reference to FIGS. 9 and 10, the goal of the initialization phase 250 is to provide statistically valid values for the pixels corresponding to the scene. These values are then used as starting points for the dynamic process of foreground and background awareness. The initialization phase 250 occurs just once, and it need not be performed in real-time. In the initialization phase 250, a certain number of frames N (e.g., N=70) of pixel value data are provided for a plurality of pixels of a search area (block 251) and are processed online or offline.

A plurality of time varying normal distributions 264, as illustratively shown in FIG. 10, are provided for each pixel of the search area based on at least the pixel value data (block 252). For example, each pixel x is considered as a mixture of five time-varying trivariate normal distributions (although any number of distributions may be used):

$$x ∼ {\sum }_{i = 1}^{5} {π}_{i} {N}_{3} ( {μ}_{i} , {\sum }_{i} ) , \\ where \text{:}$$

$${π}_{i} \geq 0 , i = 1 , … , 5 and {\sum }_{i = 1}^{5} {π}_{i} = 1$$

are the mixing proportions (weights) and N₃ (μ, Σ) denotes a trivariate normal distribution with vector mean μ and variance-covariance matrix Σ. The distributions are trivariate to account for the three component colors (Red, Green, and Blue) of each pixel in the general case of a color camera. Please note that

$$x = ( \begin{matrix}{x}^{R} \\ {x}^{G} \\ {x}^{B}\end{matrix} ) ,$$

where x^{R}, x^{G}, and x^{B} stand for the measurement received from the Red, Green, and Blue channel of the camera for the specific pixel.

For simplification, the variance-covariance matrix is assumed to be diagonal with x^{R}, x^{G}, and x^{B} having identical variance within each normal component, but not across all components (i.e., σₖ²≠σₗ² for k≠1 components). Therefore,

$$x ∼ {\sum }_{i = 1}^{5} {π}_{i} {N}_{3} [ ( \begin{matrix}{μ}_{i}^{R} \\ {μ}_{i}^{G} \\ {μ}_{i}^{B}\end{matrix} ) , {σ}_{i}^{2} I ] .$$

The plurality of time varying normal distributions are initially ordered for each pixel based on the probability that the time varying normal distribution is representative of background or foreground in the search area. Each of the plurality of time varying normal distributions 264 is labeled as foreground or background. Such ordering and labeling as background 280 or foreground 282 distributions is generally shown in FIG. 12A and is described further below in conjunction with the update cycle phase 258.

Other usable methods reported in the literature initialize the pixel distributions either randomly or with the K-means algorithm. However, random initialization may result in slow learning during the dynamic mixture model update phase and maybe even instability. Initialization with the K-means or the Expectation-Maximization (EM) method, as described in A. P. Dempster, N. M. Laird, and D. B. Rubin, “Maximum likelihood from incomplete data via the EM algorithm (with discussion),” Journal of the Royal Statistical Society B, vol. 39, pp.1-38 (1977) gives better results. The EM algorithm is computationally intensive and takes the initialization process offline for about 1 minute. In the illustrative parking lot application described previously where human and vehicular traffic is small, the short offline interval is not a problem. The EM initialization algorithm may perform better if the weather conditions are dynamic (e.g., fast moving clouds), but, if the area under surveillance were a busy plaza (many moving humans and vehicles), the online K-means initialization may be preferable.

The initial mixture model for each pixel is updated dynamically after the initialization phase 250. The update mechanism is based on the provision of update image data or incoming evidence (e.g., new camera frames providing update pixel value data) (block 256). Several components of the segmentation process may change or be updated during an update cycle of the update cycle phase 258. For example, the form of some of the distributions could change (e.g., change weight πᵢ, change mean λᵢ, and/or change variance σᵢ²). Some of the foreground states could revert to background and vice versa. Further, for example, one of the existing distributions could be dropped and replaced with a new distribution.

At every point in time, the distribution with the strongest evidence is considered to represent the pixel's most probable background state. FIG. 11 presents a visualization of the mixture of normals model, while FIG. 10 depicts the update mechanism for the mixture model. FIG. 11 shows the normals 264 of only one color for simplicity purposes at multiple times (t₀-t₂). As shown therein for pixel 263 in images 266, 268, and 270, the distributions with the stronger evidence, i.e., distributions 271, are indicative of the pixel being street during the night in image 266 and during the day in image 268. However, when the pixel 263 is representative of a moving car 267 as shown in image 270, then the pixel 263 is represented by a much weaker distribution 273.

As further shown in FIG. 9, the update cycle 258 for each pixel proceeds as follows and includes determining whether the pixel is background or foreground (block 260). First, the algorithm updates the mixture of time varying normal distributions and their parameters for each pixel based on at least the update pixel value data for the pixel (block 257). The nature of the update may depend on the outcome of a matching operation and/or the pixel value data.

For example, a narrow distribution may be generated for an update pixel value and an attempt to match the narrow distribution with each of all of the plurality of time varying normal distributions for the respective pixel may be performed. If a match is found, the update may be performed using the method of moments as further described below. Further, for example, if a match is not found, then the weakest distribution may be replaced with a new distribution. This type of replacement in the update process can be used to guarantee the inclusion of the new distribution in the foreground set as described further below.

Thereafter, the updated plurality of normal distributions for each pixel are reordered and labeled, e.g., in descending order, based on their weight values indicative of the probability that the distribution is foreground or background pixel data (block 259). The state of the respective pixel can then be committed to a foreground or background state based on the ordered and labeled updated distributions (block 260), e.g., whether the updated matched distribution (e.g., the distribution matched by the narrow distribution representative of the respective update pixel value) is labeled as foreground or background, whether the updated distributions include a new distribution representative of foreground (e.g., a new distribution generated due to the lack of a match), etc.

In one embodiment of the ordering process (block 259) of the update cycle, an ordering algorithm orders the plurality of normal distributions based on the weights assigned thereto. For example, the ordering algorithm selects the first B distributions of the plurality of time varying normal distributions that account for a predefined fraction of the evidence T:

$$B = arg {min}_{b} \{ {\sum }_{i = 1}^{b} {w}_{i} > T \} ,$$

where wᵢ, i=1, . . . ,b are representative distribution weights. These B distributions are considered, i.e., labeled, as background distributions while the remaining 5—B distributions are considered, i.e., labeled, foreground distributions. For example, ordered distributions 254 are shown in FIG. 12A. Distributions 280 are background distributions, whereas distributions 282 are foreground distributions.

In other words, during an update cycle of the update cycle phase 258, with update pixel value data being received for each pixel of the search area in an update cycle, it is determined whether the pixels are background or foreground based on the updated and re-ordered plurality of time varying normal distributions taking into account the update pixel value for the respective pixel. For example, and preferably, the algorithm checks if the incoming pixel value for the pixel being evaluated can be ascribed, i.e., matched, to any of the existing normal distributions. For example, the matching criterion used may be the Jeffreys (J) divergence measure as further described below. Such an evaluation is performed for each pixel. Thereafter, the algorithm updates the mixture of time varying normal distributions and their parameters for each pixel and the mixture of updated time varying normal distributions is reordered and labeled. The pixel is then committed to a foreground state or background state based on the reordered and labeled mixture.

One embodiment of an update cycle phase 258 is further shown in FIG. 13. Update pixel value data is received in the update cycle for each of the plurality of pixels representative of a search area (block 300). A distribution, e.g., a narrow distribution, is created for each pixel representative of the update pixel value (block 302).

Thereafter, the divergence is computed between the narrow distribution that represents the update pixel value for a pixel and each of all of the plurality of time varying normal distributions for the respective pixel (block 304). The plurality of time varying normal distributions for the respective pixel are updated in a manner depending on a matching operation as described further below and with reference to FIG. 14 (block 305). For example, a matching operation is performed searching for the time varying normal distribution having minimal divergence relative to the narrow distribution after all of divergence measurements have been computed between the narrow distribution and each of all of the plurality of time varying normal distributions for the respective pixel.

The updated plurality of time varying normal distributions for the respective pixel are then reordered and labeled (block 306) such as previously described with reference to block 259. The state of the respective pixel is committed to a foreground or background state based on the reordered and labeled updated distributions (block 307) such as previously described with reference to block 260.

Each of the desired pixels is processed in the above manner as generally shown by decision block 308. Once all the pixels have been processed, the background and/or foreground may be displayed to a user (block 310) or be used as described further herein, e.g., tracking, threat assessment, etc.

The matching operation of the update block 305 shown generally in FIG. 13 and other portions of the update cycle phase 258 may be implemented in the following manner for each pixel as described in the following sections and with reference to FIGS. 12A-12B and FIG. 14.

### The Matching Operation

The process includes an attempt to match the narrow distribution that represents the update pixel value for a pixel to each of all of the plurality of time varying normal distributions for the pixel being evaluated (block 301). Preferably, the Jeffreys divergence measure J(f,g), as discussed in H. Jeffreys, Theory of Probability, University Press, Oxford, U.K., 1948, is used to determine whether the incoming data point belongs or not (i.e., matches) to one of the existing five distributions.

The Jeffreys number measures how unlikely it is that one distribution (g), e.g., the narrow distribution representative of the update pixel value, was drawn from the population represented by the other (f), e.g., one of the plurality of time varying normal distributions. The theoretical properties of the Jeffreys divergence measure are described in J. Lin, “Divergence measures based on the shannon entropy,” IEEE Transactions on Information Theory, vol. 37, no. 1, pp. 145-151 (1991) and will not be described in detail herein for simplicity.

According to one embodiment, five existing normal distributions are used: fᵢ˜N₃(μ₁,σ₁²I), i=1, . . . ,5. However, as previously indicated more or less than five may be suitable. Since the J(f,g) relates to distributions and not to data points, the incoming data point 281 must be associated with a distribution 284, e.g., the narrow distribution described previously and as shown in FIG. 12A. The incoming distribution is constructed as g˜N₃(μ_{g},σ_{g}²I). It is assumed that:

μ_{g}=x₁ and σ_{g}²=25,

where xₜ is the incoming data point. The choice of σ_{g}²=25 is the result of experimental observation about the typical spread of successive pixel values in small time windows. The five divergence measures between g and fᵢ, i=1, . . . ,5 are computed by the following formula:

$$J ( {f}_{i} , g ) = \begin{matrix}\frac{3}{2} {( \frac{{σ}_{i}}{{σ}_{g}} - \frac{{σ}_{g}}{{σ}_{i}} )}^{2} + \\ \frac{1}{2} ( \frac{1}{{σ}_{i}^{2}} + \frac{1}{{σ}_{g}^{2}} ) {( {μ}_{g} - {μ}_{i} )}^{′} ( {μ}_{g} - {μ}_{i} ) .\end{matrix}$$

Once the five divergence measures have been calculated, the distribution fⱼ (1≦j≦5) can be found, for which:

$$J ( {f}_{j} , g ) = {min}_{1 \leq i \leq 5} \{ J ( {f}_{i} , g ) \}$$

and a match between fⱼ and g occurs if and only if

J(f₁,g)≦K*,

where K* is a prespecified cutoff value. In the case where J(fⱼ,g)>K*, then the incoming distribution g cannot be matched to any of the existing distributions.

It is particularly noted that dissimilarity is measured against all the available distributions. Other approaches, like Stauffer et al., measure dissimilarity against the existing distributions in a certain order. Depending on the satisfaction of a certain condition, the Stauffer et al. process may stop before all five measurements are taken and compared which may weaken the performance of the segmenter under certain conditions, e.g., different types of weather.

In view of the above, it is determined whether the narrow distribution (g) matches one of the plurality of time varying normal distributions for the pixel (block 303).

### Process Performed When A Match Is Found

If the incoming distribution matches to one of the existing distributions, then with use of the Methods of Moments as described below, the plurality of normal distributions are updated by pooling the incoming distribution and the matched existing distribution together to form a new pooled normal distribution (block 305A). The plurality of time varying normal distributions including the new pooled distribution are reordered and labeled as foreground or background distributions (block 306A) such as previously described herein with reference to block 259. The pooled distribution is considered to represent the current state of the pixel being evaluated and as such, the state of the pixel is committed to either background or foreground depending on the position of the pooled distribution in the reordered list of distributions (block 307A).

For example, as shown in FIG. 12A, assuming the narrow distribution 284 matches a distribution, and after update of the plurality of time varying normal distributions and subsequent reordering/labeling process, if the pooled distribution resulting from the match is a distribution 280, then the incoming pixel represented by point 281 is labeled background. Likewise, if the pooled distribution resulting from the match is a distribution 282) then the incoming pixel represented by point 281 is labeled foreground, e.g., possibly representative of a moving object.

In one embodiment, the parameters of the mixture of normal distributions are updated, e.g., a new pooled distribution is generated, using a Method of Moments (block 305A). First, some learning parameter α is introduced which weighs on the weights of the existing distributions. As such, 100α% weight is subtracted from each of the five existing weights and 100α% is added to the incoming distribution's (i.e., the narrow distribution's) weight. In other words, the incoming distribution has weight α since:

$${\sum }_{i = 1}^{5} {απ}_{i} = α {\sum }_{i = 1}^{5} {π}_{i} = α$$

and the five existing distributions have weights: πᵢ(1−α), i=1, . . . ,5.

Obviously, α is in the range of 0<α<1. The choice of α depends mainly on the choice of K*. The two quantities are inversely related. The smaller the value of K*, the higher the value of α and vice versa. The values of K* and α are also affected by the amount of noise in the monitoring area. As such, for example, if an outside region was being monitored and there was a lot of noise due to environmental conditions (i.e., rain, snow, etc.), then a “high” value of K* and thus a “small” value of a is needed, since failure to match one of the distributions is very likely to be caused by background noise. On the other hand, if an indoor region were being monitored where the noise is almost nonexistent, then preferable a “small” value of K* and thus a “higher” value of α is needed because any time a match to one of the existing five distributions is not attained, the non-match is very likely to occur due to some foreground movement (since the background has almost no noise at all).

If a match takes place between the new distribution g and one of the existing distributions fⱼ, where 1≦j≦5, then the weights of the mixture model are updated as follows:

π_{1.t}=(1−α)π_{1.t-1} i=1, . . . ,5 and i≠j π111=(1−α)π_{j.t-1}+α.

The mean vectors and the variances thereof are also updated. If w₁ is: (1−α)π_{j,t-1} (i.e., w₁ is the weight of the jth component which is the winner in the match before pooling the matched distribution with the new distribution g), and if w₂=α which is the weight of the pooled distribution, then a factor (p) can be defined as:

$$ρ = \frac{{w}_{2}}{{w}_{1} + {w}_{2}} = \frac{α}{( 1 - α ) {π}_{j , t - 1} + α} .$$

Using the method of moments, as discussed in G. J. McLachlan and K. E. Basford, Mixture Models Inference and Applications to Clustering, Marcel Dekker, New York, N.Y. (1988), the following results:

μ_{j,t}=(1−ρ)μ_{j.t-1}+ρμ_{g}

σ_{j,t}²=(1−ρ)σ_{j,t-1}²+ρσ_{g}²+ρ(1−ρ)(xₜ−μ_{j.t-1})(xₜ−μ_{j,t-1}),

while the other four (unmatched) distributions keep the same mean and variance that they had at time t-1.

### Process Performed When A Match Is Not Found

When a match is not found (i.e., min_{1≦i≦5} K(fᵢ,g)>K*), the plurality of normal distributions are updated by replacing the last distribution in the ordered list (i.e., the distribution most representative of foreground state) with a new distribution based on the update pixel value (block 305B) and which guarantees the pixel is committed to a foreground state (e.g., the weight assigned to the distribution such that it must be foreground). The plurality of time varying normal distributions including the new distribution are reordered and labeled (block 306B) (e.g., such as previously described herein with reference to block 259) with the new distribution representative of foreground and the state of the pixel committed to a foreground state (block 307B).

The parameters of the new distribution that replaces the last distribution of the ordered list are computed as follows. The mean vector μ₅ is replaced with the incoming pixel value. The variance σ₅² is replaced with the minimum variance from the list of distributions. As such, the weight of the new distribution can be computed as follows:

$${w}_{5 \cdot t + 1} = \frac{1 - T}{2} ,$$

where T is the background threshold index. This computation guarantees the classification of the current pixel state as foreground. The weights of the remaining four distributions are updated according to the following formula:

$${w}_{i \cdot t + 1} = {w}_{i \cdot t} + \frac{{w}_{5 \cdot t} - ( 1 - T ) / 2}{4} .$$

The above matching approach is used, at least in part, because the approach implemented by the normal mixture modeling reported in Stauffer et al. is not adequate in many circumstances, e.g., where monitoring is outdoors in an environment that features broken clouds due to increased evaporation from lakes and brisk winds; such small clouds of various density pass rapidly across the camera's field of view in high frequency.

In Stauffer et al., the distributions of the mixture model, as shown in FIG. 12B, are always kept in a descending order according to w/σ, where w is the weight and σ the variance of each distribution. Then, incoming pixels are matched against the ordered distributions in turn from the top towards the bottom (see arrow 283) of the list. If the incoming pixel value is found to be within 2.5 standard deviations of a distribution, then a match is declared and the process stops.

However, for example, this method is vulnerable (e.g., misidentifies pixels) in at least the following scenario. If an incoming pixel value is more likely to belong, for example, to distribution 4 but still satisfies the 2.5 standard deviation criterion for a distribution earlier in the queue (e.g., 2), then the process stops before it reaches the right distribution and a match is declared too early (see FIG. 12B). The match is followed with a model update that favors unjustly the wrong distribution. These cumulative errors can affect the performance of the system after a certain time period. They can even have an immediate and serious effect if one distribution (e.g., 2) happens to be background and the other (e.g., 4) foreground.

For example, the above scenario can be put into motion by fast moving clouds. In Stauffer et al., when a new distribution is introduced into the system, it is centered around the incoming pixel value 281 and is given an initially high variance and small weight. As more evidence accumulates, the variance of the distribution drops and its weight increases. Consequently, the distribution advances in the ordered list of distributions.

However, because the weather pattern is very active, the variance of the distribution remains relatively high, since supporting evidence is switched on and off at high frequency. This results in a mixture model with distributions that are relatively spread out. If an object of a certain color happens to move in the scene during this time, it generates incoming pixel values that may marginally match distributions at the top of the queue and therefore be interpreted as background. Since the moving clouds affect wide areas of the camera's field of view, post-processing techniques are generally ineffective to cure such deficiencies.

In contrast, the preferable method of segmentation according to the present invention described above, does not try to match the incoming pixel value from the top to the bottom of the ordered distribution list. Rather, preferably, the method creates a narrow distribution 284 that represents the incoming data point 281. Then, it attempts to match a distribution by finding the minimum divergence value between the incoming narrow distribution 284 and “all” the distributions 280, 282 of the mixture model. In this manner, the incoming data point 281 has a much better chance of being matched to the correct distribution.

Yet further, with reference to FIG. 3, as described above, a statistical procedure is used to perform online segmentation of foreground pixels from background; the foreground potentially corresponding to moving objects of interest, e.g., people and vehicles (block 106). Following segmentation, the moving objects of interest are then tracked (block 108). In other words, a tracking method such as that illustratively shown in FIG. 15 is used to form trajectories or object paths traced by one or more moving objects detected in the search area being monitored.

Although other suitable tracking methods may be used, preferably, the tracking method includes the calculation of blobs (i.e., groups of connected pixels), e.g., groups of foreground pixels adjacent one another, or blob centroids thereof (block 140) which may or may not correspond to foreground objects for use in providing object trajectories or object paths for moving objects detected in the search area. Such blob centroids may be formed after applying a connected component analysis algorithm to the foreground pixels segmented from the background of the image data.

For example, a standard 8-connected component analysis algorithm can be used. The connected component algorithm filters out blobs, i.e., groups of connected pixels, that have an area less than a certain number of pixels. Such filtering is performed because such a small number of pixels in an area are generally representative of noise as opposed to a foreground object. For example, the connected component algorithm may filter out blobs with an area less than α=3×9=27 pixels. For example, 27 pixels may be the minimal pixel footprint of the smallest object of interest in the imaging device's field of view, e.g., 27 pixels may be the footprint of a human.

Once blobs, e.g., groups of pixels, are identified as being representative of a foreground object in the search area, an algorithm is provided that is employed to group the blob centroids identified as foreground objects in multiple frames into distinct trajectories or object paths. Preferably, a multiple hypotheses tracking (MHT) algorithm 141 is employed to perform the grouping of the identified blob centroids representative of foreground objects into distinct trajectories.

Although MHT is considered to be a preferred approach to multi-target tracking applications, other methods may be used. MHT is a recursive Bayesian probabilistic procedure that maximizes the probability of correctly associating input data with tracks. It is preferable to other tracking algorithms because it does not commit early to a particular trajectory. Such early commitment to a path or trajectory may lead to mistakes. MHT groups the input data into trajectories only after enough information has been collected and processed.

In this context, MHT forms a number of candidate hypotheses (block 144) regarding the association of input data, e.g., identified blobs representative of foreground objects, with existing trajectories, e.g., object paths established using previous frames of data. MHT is particularly beneficial for applications with heavy clutter and dense traffic. In difficult multi-target tracking problems with crossed trajectories, MHT performs effectively as opposed to other tracking procedures such as the Nearest Neighbor (NN) correlation and the Joint Probabilistic Data Association (JPDA), as discussed in S. S. Blackman, Multiple-Target Tracking with Radar Applications, Artech House, Norwood, Mass. (1986).

FIG. 15 depicts one embodiment of an architecture of a MHT algorithm 141 employed for tracking moving objects according to the present invention. An integral part of any tracking system is the prediction module (block 148). Prediction provides estimates of moving objects' states and is preferably implemented as a Kalman filter. The Kalman filter predictions are made based on a priori models for target dynamics and measurement noise.

Validation (block 142) is a process which precedes the generation of hypotheses (block 144) regarding associations between input data (e.g., blob centroids) and the current set of trajectories (e.g., tracks based on previous image data). The function of validation (block 142) is to exclude, early-on, associations that are unlikely to happen, thus limiting the number of possible hypotheses to be generated.

Central to the implementation of the MHT algorithm 141 is the generation and representation of track hypotheses (block 144). Tracks, i.e., object paths, are generated based on the assumption that a new measurement, e.g., an identified blob, may: (1) belong to an existing track, (2) be the start of a new track, (3) be a false alarm or otherwise mis-identified as a foreground object. Assumptions are validated through the validation process (block 142) before they are incorporated into the hypothesis structure.

For example, a complete set of track hypotheses can be represented by a hypothesis matrix as shown by the table 150 in FIG. 16. The hypothetical situation represented in the table corresponds to a set of two scans of 2 and 1 measurements made respectively on frame k=1 and k+1 =2.

The notations regarding the table can be clarified as follows. A measurement zⱼ(k) is the jth observation (e.g., blob centroid) made on frame k. In addition, a false alarm is denoted by 0, while the formation of a new track (T_{newID}) generated from an old track (T_{oldID}) is shown as T_{newID}(T_{oldID}). The first column in this table is the Hypothesis index.

In this exemplary situation, a total of 4 hypotheses are generated during scan 1, and 8 more hypotheses are generated during scan 2. The last column lists the tracks that the particular hypothesis contains (e.g., hypothesis H₈ contains tracks no. 1 and no. 4). The row cells in the hypothesis table denote the tracks to which the particular measurement zⱼ(k) belongs (e.g., under hypothesis H₁₀, the measurement z₁(2) belongs to track no. 5).

A hypothesis matrix is represented computationally by a tree structure 152 as is schematically shown in FIG. 17. The branches of the tree 152 are, in essence, the hypotheses about measurements and track associations. As is evident from the above exemplary situation, the hypothesis tree 152 of FIG. 17 can grow exponentially with the number of measurements.

Different measures may be applied to reduce the number of hypotheses. For example a first measure is to cluster the hypotheses into disjoint sets, such as in D. B. Reid, “An algorithm for tracking multiple targets,” IEEE Transactions on Automatic Control, vol. 24, pp. 843-854 (1979). In this sense, tracks which do not compete for the same measurements compose disjoint sets which, in turn, are associated with disjoint hypothesis trees. Our second measure is to assign probabilities on every branch of hypothesis trees. The set of branches with the N_{hypo} highest probabilities are only considered. Various other implementations of the MHT algorithm are described in I. J. Cox and S. L. Hingorani, “An efficient implementation of reid's multiple hypothesis tracking algorithm and its evaluation for the purpose of visual tracking,” IEEE Transactions on Pattern Analysis and Machine Intelligence, vol. 18, no. 2, pp. 138-150 (1996).

With the provision of object tracks, i.e., trajectories, using the computer vision system 22, an assessment module 24 as shown in FIG. 2 may be provided to process such computer vision information and to determine if moving objects are normal or abnormal, e.g., threatening or non-threatening. The assessment analysis performed employing the assessment module 24 may be done after converting the pixel coordinates of the object tracks into a real world coordinate system set-up by a CAD drawing of a search area. As such, one can use well-known landmarks in the search area to provide content for evaluating intent of the moving object. For example, such landmarks for a parking lot may include: individual parking spots, lot perimeter, power poles, and tree lines. Such coordinate transformation may be achieved through the use of an optical computation package, such as CODE V software application available from Optical Research Associate (Pasadena, Calif.). However, other applications performing assessment analysis may not require such a set up.

In one embodiment as shown in FIG. 2, the assessment module 24 includes feature assembly module 42 and a classification stage 48. The assessment module 24 is preferably employed to implement the assessment method 160 as shown in FIG. 18.

The assessment method 160, as indicated above, is preferably used after the tracks of moving objects are converted into the coordinate system of the search area, e.g., a drawing of search area including landmarks (block 162). Further, predefined feature models 57 characteristic of normal and/or abnormal moving objects are provided for the classification stage 48 (block 164). The classification state 48, e.g., a threat classification stage, includes normal feature models 58 and abnormal feature models 59.

As used herein, a feature model may be any characteristics of normal or abnormal object paths or information associated therewith. For example, if no planes are to fly in an air space being monitored, then any indication that a plane is in the air space may be considered abnormal, e.g., detection of a blob may be abnormal in the air space. Further, for example, if no blobs are to be detected during a period of time in a parking lot, then the detection of a blob at a time that falls in this quiet range may be a feature model. As one can clearly recognize, the list of feature models is too numerous to list and encompasses not only threatening and/or non-threatening feature models, but may include various other types of feature models such as, for example, a feature model to count objects passing a particular position, e.g., for counting the number of persons passing a sculpture and stopping to look for a period of time.

The feature assembly module 42 of the assessment module 24 provides object path information such as features 43 that may include, for example, trajectory information representative of the object paths, information collected regarding the object paths (e.g., other data such as time of acquisition), or information computed or collected using the trajectory information provided by the computer vision module 32, e.g., relevant higher level features on a object basis such as object path length (e.g., a per vehicle/pedestrian basis) (block 166). In other words, object path data such as features may include, but are clearly not limited to, moving object trajectory information, other information collected with regard to object paths, calculated features computed using object path information, or any other parameter, characteristic, or relevant information related to the search area and moving objects therein.

The calculated features may be designed to capture common sense beliefs about normal or abnormal moving objects. For example, with respect to the determination of a threatening or non-threatening situation, the features are designed to capture common sense beliefs about innocuous, law abiding trajectories and the known or supposed patterns of intruders.

In one embodiment, the calculated features for a search area, such as a parking lot or other search area where assessment of threatening events (e.g., burglar) is to be performed, may include, for example:

number of sample points

starting position (x,y)

ending position (x,y)

path length

distance covered (straight line)

distance ratio (path length/distance covered)

start time (local wall clock)

end time (local wall clock)

duration

average speed

maximum speed

speed ratio (average/maximum)

total turn angles (radians)

average turn angles

number of “M” crossings

Most of the features are self-explanatory, but a few may not be obvious. The wall clock is relevant since activities of some object paths are automatically suspect at certain times of day, e.g., late night and early morning.

The turn angles and distance ratio features capture aspects of how circuitous was the path followed. For example, legitimate users of the facility, e.g., a parking lot, tend to follow the most direct paths permitted by the lanes (e.g., a direct path is illustrated in FIG. 20B) In contrast, “Browsers” may take a more serpentine course. FIG. 20B shows a non-threatening situation 410 wherein a parking lot 412 is shown with a non-threatening vehicle path 418 being tracked therein.

The “M” crossings feature attempts to monitor a well-known tendency of car thieves to systematically check multiple parking stalls along a lane, looping repeatedly back to the car doors for a good look or lock check (e.g., two loops yielding a letter “M” profile). This can be monitored by keeping reference lines for the parking stalls and counting the number of traversals into stalls. An “M” type pedestrian crossing is captured as illustrated in FIG. 20A. FIG. 20A particularly shows a threatening situation 400 wherein a parking lot 402 is shown with a threatening person path 404.

The features provided (e.g., features associated with object tracks) are evaluated such as by comparing them to predefined feature models 57 characteristic of normal and abnormal moving objects in the classifier stage (block 168). Whether a moving object is normal or abnormal is then determined based on the comparison between the features 43 calculated for one or more object paths by feature assembly module 42 and the predefined feature models 57 accessible (e.g., stored) in classification stage 48 (block 170). Further, for example, if an object path is identified as being threatening, an alarm 60 may be provided to a user. Any type of alarm may used, e.g., silent, audible, video, etc.

In addition to the predefined feature models 57 which are characterized by common sense and known normal and abnormal characteristics, e.g., defined by a user through a graphical user interface, a training module 44 for providing further feature models is provided. The training module 44 may be utilized online or offline.

In general, the training module 44 receives the output of the feature assembly module 42 for object paths recorded for a particular search area over a period of time. Such features, e.g., object path trajectories and associated information including calculated information concerning the object path (together referred to in the drawing as labeled cases), may be collected and/or organized using a database structure. The training module 44 is then used to produce one or more normal and/or abnormal feature models based on such database features for potential use in the classification stage 48.

One illustrative embodiment of such a training module 44 and a process associated therewith shall be described with reference to FIG. 19. In general, the training process 350 provides a clustering algorithm 52 that assists in production of more clear descriptions of object behavior, e.g., defined feature models, by a feature model development module 54. For example, the training data used for the training process includes, but is clearly not limited to, labeled trajectories 50 and corresponding feature vectors. Such data may be processed together by a classification tree induction algorithm, such as one based on W. Buntine, “Learning classification trees,” Statistics and Computing, vol. 2, no. 2, pp. 63-73 (1992).

More specifically, as described with reference to FIG. 19, object paths and calculated features associated with such object paths are acquired which are representative of one or more moving objects over time (block 352). For example, such object paths and calculated features associated therewith are acquired over a period of weeks, months, etc.

The object paths and the associated calculated features are grouped based on certain characteristics of such information (block 354). Such object tracks are grouped into clusters. For example, object paths having a circuitousness of a particular level may be grouped into a cluster, object paths having a length greater than a predetermined length may be grouped into a cluster, etc. In other words, object paths having commonality based on certain characteristics are grouped together (block 354).

The clusters are then analyzed to determine whether they are relatively large clusters or relatively small clusters. In other words, the clusters are somewhat ordered and judged to be either large or small based on the number of object tracks therein. Generally, large clusters have a particularly large number of object tracks grouped therein when compared to small clusters and can be identified as relatively normal object tracks (block 358). In other words, if moving objects take generally the same path many times over a particular period of time, then the object paths corresponding to the moving objects are generally normal paths, e.g., object paths representative of a non-threatening moving object. The object path or features associated therewith may be then used as a part of a predefined feature model to later identify object tracks as normal or abnormal such as in the threat classification stage (block 360). In other words, a new feature model may be defined for inclusion in the classification stage 48 based on the large cluster.

Relatively small clusters of object paths, which may include a single object track, must be analyzed (block 362). Such analysis may be performed by a user of a system reviewing the object path via a graphical user interface to make a human determination of whether the object tracks of the smaller clusters or the single object track is abnormal, e.g., threatening (block 364).

If the object track or tracks of the small clusters are abnormal, then the feature may be used as part of a predefined feature model to identify object paths that are abnormal, e.g., used as a feature model in the classification stage 48 (block 366). If, however, the object path or paths are judged as being just a normal occurrence, just not coinciding with any other occurrence of such object path or very few of such object paths, then the object path or paths being analyzed may be disregarded (block 368).

The clustering method may be used for identification of normal versus abnormal object tracks for moving objects independent of how such object tracks are generated. For example, as shown in FIG. 2, such object tracks are provided by a computer vision module 32 receiving information from a plurality of imaging devices 30. However, object tracks generated by a radar system may also be assessed and analyzed using the assessment module 24 and/or a cluster analysis tool as described with regard to training module 44.

All references cited herein are incorporated in their entirety as if each were incorporated separately. This invention has been described with reference to illustrative embodiments and is not meant to be construed in a limiting sense. Various modifications of the illustrative embodiments, as well as additional embodiments of the invention, will be apparent to persons skilled in the art upon reference to this description.

What is claimed is:

1. A method for use in monitoring a search area, the method comprising:
providing a plurality of frames of image pixel data, wherein the plurality of frames of image pixel data include at least one frame of image pixel data representative of a corresponding field of view for each of a plurality of imaging devices, wherein each field of view of each imaging device comprises a field of view portion which overlaps with at least one other field of view of another imaging device; and
combining the plurality of frames of image pixel data into a single image representative of at least a portion of the search area by computing at least one homography transformation matrix indicative of a coordinate relationship between image pixel data for fields of view of at least one pair of the imaging devices that comprise field of view portions which overlap with each other.

2. The method of claim 1, wherein the fields of view of the plurality of imaging devices provide for coverage of the entire search area.

3. The method of claim 1, wherein the field of view portion which overlaps is greater than about 25 percent of the field of view of the imaging device.

4. The method of claim 3, wherein the field of view portion which overlaps is less than about 85 percent of the field of view of the imaging device.

5. The method of claim 1, wherein computing at least one homography transformation matrix comprises computing at least one homography transformation matrix based on a plurality of landmark points of commonality in the field of view portions which overlap for the at least one pair of the imaging devices.

6. The method of claim 1, wherein combining the plurality of frames of image pixel data into a single image representative of at least a portion of the search area further comprises using the homography transformation matrix to fuse the plurality of frames of image pixel data into a single image having a global coordinate system.

7. The method of claim 1, wherein the method further comprises positioning a plurality of imaging devices to cover an entire defined search area having an outer perimeter edge, wherein each field of view of each imaging device comprises a field of view portion which overlaps with at least one other field of view of another imaging device, wherein the field of view portion which overlaps is greater than about 25 percent of the field of view of the imaging device and less than about 85 percent.

8. The method of claim 7, wherein the field of view portion which overlaps is greater than about 35 percent.

9. The method of claim 7, wherein positioning the plurality of imaging devices comprises:
positioning a first imaging device at a first installation site such that a field of view for the first imaging device covers at least a region of the defined search area along at least a portion of the outer perimeter edge thereof;
positioning one or more additional imaging devices at the first installation site, if necessary, to cover with fields of view thereof one or more regions of the defined search area not covered by the field of view of the first imaging device; and
positioning one or more additional imaging devices at one or more additional installation sites, if necessary, to cover with fields of view thereof one or more additional regions of the defined search area not covered by the fields of view of the imaging devices positioned at the first installation site.

10. The method of claim 9, wherein positioning the plurality of imaging devices further comprises determining the limiting range of at least one of the plurality of imaging devices indicative of the useful coverage area for the imaging device, wherein the limiting range is based on the field of view of the imaging device and the resolution of the imaging device.

11. The method of claim 1, wherein the method further comprises tracking a moving object within the single image resulting in a moving object path for the moving object.

12. The method of claim 11, wherein the method further comprises determining whether the moving object path is normal or abnormal.

13. A system for use in monitoring a search area, the system comprising:
a plurality of imaging devices operable to provide a plurality of frames of image pixel data, wherein the plurality of frames include at least one frame of image pixel data representative of a corresponding field of view for each of the plurality of imaging devices, wherein each field of view of each imaging device comprises a field of view portion which overlaps with at least one other field of view of another imaging device; and
a computing apparatus operable to combine the plurality of frames of image pixel data into a single image representative of at least a portion of the search area by computing at least one homography transformation matrix indicative of a coordinate relationship between image pixel data for fields of view of at least one pair of the imaging devices that comprise field of view portions which overlap with each other.

14. The system of claim 13, wherein the field of view portion which overlaps is greater than about 25 percent of the field of view of the imaging device.

15. The system of claim 14, wherein the field of view portion which overlaps is less than about 85 percent of the field of view of the imaging device.

16. The system of claim 13, wherein the computing apparatus is further operable to compute at least one homography transformation matrix based on a plurality of landmark points of commonality in the field of view portions which overlap for the at least one pair of the imaging devices.

17. The system of claim 16, wherein the computing apparatus is further operable to use the homography transformation matrix to fuse the plurality of frames of image pixel data into a single image having a global coordinate system.

18. The system of claim 13, wherein the plurality of imaging devices are positioned to cover an entire defined search area having an outer perimeter edge, wherein each field of view of each imaging device comprises a field of view portion which overlaps with at least one other field of view of another imaging device, wherein the field of view portion which overlaps is greater than about 25 percent and less than about 85 percent of the field of view of the imaging device.

19. The system of claim 18, wherein the field of view portion which overlaps is greater than about 35 percent.

20. The system of claim 13, wherein the plurality of imaging devices comprise:
a first imaging device positioned at a first installation site such that a field of view for the first imaging device covers at least a region of the defined search area along at least a portion of the outer perimeter edge thereof;
one or more additional imaging devices positioned at the first installation site, if necessary, to cover with fields of view thereof one or more regions of the defined search not covered by the field of view of the first imaging device; and
one or more additional imaging devices positioned at one or more additional installation sites, if necessary, to cover with fields of view thereof one or more additional regions of the defined search area not covered by the fields of view of the imaging devices positioned at the first installation site.

21. The system of claim 20, wherein the computing apparatus is further operable to determine the limiting range for at least one of the plurality of imaging devices indicative of the useful coverage area for the imaging device, wherein the limiting range is based on the field of view of the imaging device and the resolution of the imaging device.

22. The system of claim 13, wherein the computing apparatus is further operable to track a moving object within the single image resulting in a moving object path for the moving object.

23. The system of claim 22, wherein the computing apparatus is further operable to determine whether the moving object path is normal or abnormal.

24. A method for use in monitoring a search area, wherein the method comprises:
defining a search area having an outer perimeter edge;
positioning a first imaging device at a first installation site such that a field of view for the first imaging device covers at least a region of the defined search area along at least a portion of the outer perimeter edge thereof;
positioning one or more additional imaging devices at the first installation site, if necessary, to cover with fields of view thereof one or more additional regions of the defined search area not covered by the field of view of the first imaging device; and
positioning one or more additional imaging devices at one or more additional installation sites, if necessary, to cover with fields of view thereof one or more additional regions of the defined search area not covered by fields of view of the imaging devices positioned at the first installation site, wherein each field of view of each imaging device comprises a field of view portion which overlaps with at least one other field of view of another imaging device, wherein the field of view portion which overlaps is greater than about 25 percent of the field of view of the imaging device.

25. The method of claim 24, wherein the fields of view of the imaging devices provide for coverage of the entire search area.

26. The method of claim 24, wherein the field of view portion which overlaps is less than about 85 percent of the field of view of the imaging device.

27. The method of claim 24, wherein positioning one or more of the imaging devices is performed based on at least a calculated limiting range of at least one of the imaging devices indicative of the useful coverage area for the imaging device, wherein the limiting range is based on the field of view of the imaging device and the resolution of the imaging device.

28. The method of claim 24, wherein the method further comprises:
providing a plurality of frames of image pixel data, wherein the plurality of frames of image pixel data include at least one frame of image pixel data representative of a corresponding field of view for each of the imaging devices; and
combining the plurality of frames of image pixel data into a single image representative of at least a portion of the search area.

29. The method of claim 28, wherein the method further comprises tracking a moving object within the single image resulting in a moving object path for the moving object.

30. The method of claim 29, wherein the method further comprises determining whether the moving object path is normal or abnormal.

31. A system for use in monitoring a search area, the system comprising:
a first imaging device positioned at a first installation site such that a field of view for the first imaging device covers at least a region of a defined search area along an outer perimeter edge thereof;
one or more additional imaging devices positioned at the first installation site, if necessary, to cover with fields of view thereof one or more regions of the defined search area not covered by the field of view of the first imaging device; and
one or more additional imaging devices positioned at one or more additional installation sites, if necessary, to cover with fields of view thereof one or more additional regions of the defined search area not covered by the fields of view of the imaging devices positioned at the first installation site, wherein each field of view of each imaging device comprises a field of view portion which overlaps with at least one other field of view of another imaging device, wherein the field of view portion which overlaps is greater than about 25 percent of the field of view of the imaging device.

32. The system of claim 31, wherein the fields of view of the imaging devices provide for coverage of the entire defined search area.

33. The system of claim 31, wherein the field of view portion which overlaps is less than about 85 percent of the field of view of the imaging device.

34. The system of claim 31, wherein the position of one or more of the imaging devices is based on at least a calculated limiting range of at least one of the imaging devices indicative of the useful coverage area for the imaging device, wherein the limiting range is based on the field of view of the imaging device and the resolution of the imaging device.

35. The system of claim 31, wherein the system further comprises a computing apparatus operable to receive a plurality of frames of image pixel data, wherein the plurality of frames of image pixel data include at least one frame of image pixel data representative of a corresponding field of view for each of the imaging devices, and further wherein the computing apparatus is further operable to combine the plurality of frames of image pixel data into a single image representative of at least a portion of the defined search area.

36. The system of claim 35, wherein the computer apparatus is further operable to track a moving object within the single image resulting in a moving object path for the moving object.

37. The system of claim 36, wherein the computer apparatus is further operable to determine whether the moving object path is normal or abnormal.

38. A method for use in monitoring a search area, wherein the method comprises:
defining a search area; and
positioning a plurality of imaging devices at one or more installation sites such that corresponding fields of view for the plurality of imaging devices cover the entire search area, wherein each field of view of each imaging device comprises a field of view portion which overlaps with at least one other field of view of another imaging device, wherein the field of view portion which overlaps is greater than about 25 percent of the field of view of the imaging device.

39. The method of claim 38, wherein the field of view portion which overlaps is less than about 85 percent of the field of view of the imaging device.

40. The method of claim 38, wherein positioning the plurality of imaging devices at the one or more installation sites comprises positioning one or more of the imaging devices or adjusting the field of view of one or more imaging devices based on at least a calculated limiting range of at least one of the imaging devices indicative of the useful coverage area for the imaging device, wherein the limiting range is based on the field of view of the imaging device and the resolution of the imaging device.

41. The method of claim 38, wherein the method further comprises:
providing a plurality of frames of image pixel data, wherein the plurality of frames of image pixel data include at least one frame of image pixel data representative of a corresponding field of view for each of the plurality of imaging devices; and
combining the plurality of frames of image pixel data into a single image representative of at least a portion of the search area.

42. The method of claim 41, wherein the method further comprises tracking a moving object within the single image resulting in a moving object path for the moving object.

43. The method of claim 41, wherein the method further comprises determining whether the moving object path is normal or abnormal.
